(19) United States
(12) Patent Application Publication
(10) Pub. No.: US 2018/0361579 A1
(43) Pub. Date: Dec. 20, 2018

(54) MOTION MODEL SYNTHESIZER METHODS AND SYSTEMS

(71) Applicant: Michael Kelly, Perth (CA)

(72) Inventor: Michael Kelly, Perth (CA)

(21) Appl. No.: 15/990,721

(22) Filed: May 28, 2018

Related U.S. Application Data
(60) Provisional application No. 62/522,389, filed on Jun. 20, 2017.

(51) Int. Cl. B25J 9/16; B25J 19/00; G06F 17/50

(52) U.S. Cl. CPC B25J 9/1605; G06F 17/5009; B25J 19/007

(57) ABSTRACT

Articulated assemblies are all around us in nature as well as within the artificial environments and artificial systems we create. Computer based simulations are used to view, analyze, and modify motion specifications and sequences for articulated assemblies in the generation of avatars for multimedia and designing robotic/android systems. Articulated assembly specifications along with terrain and physical laws are employed in establishing an actuation and motion sequence for the assembly. However, other factors such as emotion, state of mind, etc. impact how the assembly actually moves and the physical aspect of the assembly. Embodiments of the invention allow for management of cyclic and acyclic elements to the overall motion through graphical user interfaces as well as the rapid establishment of new motion models through fractional combination of existing motion models as well as the association of a motion model to multiple articulated assemblies allowing simulations of herds, crowds etc.

This patent application claims the benefit of priority from U.S. Provisional Patent Application 62/522,389 filed Jun. 20, 2017 entitled “Motion Model Synthesizer”, the entire contents of which are herein incorporated by reference.

### FIELD OF THE INVENTION

This invention relates to the design and simulation of articulated assemblies, such as robots or animated characters, and more specifically to the model used to represent motions of such assemblies, and to systems and methods for viewing, analysing, and modifying of such models.

### BACKGROUND OF THE INVENTION

Articulated assemblies are comprised of rigid or flexible segments of arbitrary shape, and the joints between them. Segments may additionally have mechanisms attached to them which will affect the way the segment will interact with an obstruction, a support surface, or other segments. For example, a segment may have a wheel or track mechanism at one end to provide control of the endpoint when it is in contact with a support surface instead of relying on the static physical properties of the segment and the support surface such as static and dynamic coefficients of friction. Assemblies may be or contain tree-shaped structures of connected segments. Assemblies may be or contain loops of connected segments. Assemblies may include specifications for passive driving elements such as springs and dampers. Assemblies may include specifications for active driving elements such as motors. Assemblies may or may not be anchored to an immovable reference point. An example of an unanchored assembly is a free-standing legged robot whilst an example of an anchored assembly is a manufacturing robot arm fastened to a workstation bench.

Representations of articulated assemblies, desired motions for them, the terrain over which they will move, and the physical laws which motion should obey are the four elements central to the design and simulation of actual motion sequences of those assemblies, and the actuations of the active driving elements of those assemblies to produce the desired motions.

In a design system, topological representations of articulated assemblies are constructed by specifying the individual bodies, or segments, in the assembly and the joints between those segments. The properties and behaviors of the segments and joints in the assembly may be specified as part of the design process, or separately in a different design system at the same or other time. Properties of segments may include, for example, geometry and mass, and may include any such properties of the assembly that might affect its actuations or the resulting motions. Properties of joints include the number and nature of the degrees of freedom for each joint, and may include, for example, limits on motion, a spring constant, and maximum force or torque values for active drivers associated with a degree of freedom. The design stage may be a precursor to constructing or modifying a physical assembly.

In the same or different design system, terrain properties are specified. The specification may contain, for example, i) spatial information, such as the altitude and slope of the terrain at each point, and the presence of steps, ii) material information, such as the static and dynamic coefficients of friction and the spring constant representing the elasticity at each point on the terrain, iii) fluid cover information, such as the depth of fluid, its density, its viscosity, and its velocity at each point on the terrain, and iv) obstruction information, including immobile objects such as building and trees, or mobile objects such as vehicles or other assemblies, which may or may not completely prevent an assembly from occupying the same space as the obstruction.

In the same or different design system, motions for an articulated assembly are specified. The specification may contain, for example, i) spatial information, such as the path to follow for the motion, ii), ii) behavioral information, such as the speed at which motion should occur, iii) timing information such as time instants at, or intervals during which, an event should occur, or time intervals over which a given motion or portion of the motion should occur, and iv) information about cyclic or acyclic motion elements to be superimposed on a base motion. The motion specification may include elements at different levels of detail. An example of a high-level specification is that a legged assembly's overall motion should be to walk, skip, run or hop. An example of a low-level specification is an exact path in space and time to be followed by the assembly, one of its segments, or indeed one point on one of its segments. The motion specification may also include actuations of driving elements, for example the application of a given torque at a given joint for a particular time interval.

Motion specifications will often, but not always, be associated with a legged gait. The elements making up a motion specification may be cyclic or acyclic. The elements making up a motion specification may include:
elements associated with individual or concurrently moving assembly elements, such as the flexing of an ankle, the swinging of a leg, or the swivel of the hips;
combinations of individual elements, such as the opposing swing of arms and legs, or the pulling in of the arms to do a pirouette;
combinations of individual or combination element qualities that can be characterized as a type of motion, such as lethargic, which is slower and less pronounced, happy, which has head held high and a step with a skip in it, or angry which has fists clenched, arms rigid, and shoulders canted forward, and
a set of measures indicating how much of each of the above are present, such as a walk which is 75% angry and 25% lethargic meaning, for example, that the angry walk is slower and the assembly has fists which are not as tightly clenched.

Acyclic elements may be deviations from or additions to the cyclic motion. Cyclic elements may be viewed as a complex curve which repeats, or as the frequency components of such a curve, as are extracted using a Fourier transform.

The content of a motion specification may be provided in different ways. It may be entered or read in textually or via options chosen from a menu, it may be generated using a graphical interface, for example using an electronic version of an assembly as a marionette, or it may be derived from a motion capture of a physical assembly, possibly a living being. In the case of motion capture information, it may be or have been modified before being supplied as input to the current invention.

In the same or different design system, the physical laws of motion to be obeyed by the assembly may be specified. These may or may not be the same physical laws governing our real world. For example, gravity or spring forces may vary as defined by a square law, as in the real world, or they may vary according to powers other than 2. As another example, forces or torques may influence objects linearly, via equations such as F=ma or τ=Ia, or according to a power other than 1. Alternatively, properties of the simulated environment may have different rules of electromagnetism, gravity, etc.

The motion of an articulated assembly can be complex even for a simple assembly because the number of possible states is, at worst, the product of all of the possible states of the individual elements, and because a motion specification also includes an indication of a desired sequence of those states. Further, the human observer is sensitive to many aspects of motion, meaning that the specification of motion must both conform to the expectations of a viewer, and allow for artistic input so that motions of different character can be specified. Further still, and particularly when real physical systems are involved, e.g., the control of a legged robot, the laws of physics must be adhered to, within tolerances, so that realization of that motion can be done in a physically correct way.

The current state of the art extracts or generates a motion model from a complete assembly, e.g., a whole character. Accordingly, there remains a need in the art for structures and methods for constructing a motion model incrementally as a character is constructed. Elements in a motion model for, for example, the motion of a pair of legs are added when leg pair is added.

The current state of the art does not include structures and methods for representing acyclic motions as portions of cyclic motions. This is very useful for maintaining the consistency of motion characteristics across cyclic and acyclic motions. An example of an acyclic motion is the transitioning from a walking gait to a running gait. By concatenating instances of i) the desired acyclic motion, ii) inverses of the desired acyclic motion, iii) mirrors of i) and ii), a cycle can be defined, i.e., a sequence of motion that returns to its initial state, which incorporates the desired acyclic sub-sequence. A cycle so defined can be used, via the viewing and editing tools for any other motion cycle model, to ensure that, for this example, the leg motion of the transition is consistent with the leg motion of the walk in ingress and the run on egress. Furthermore, again for this model, the cycle can be used to ensure that the arm motion is consistent with the walk and run gaits at ingress and egress, respectively. Accordingly, there is a need in the art for structures and methods for constructing motion cycle models containing desired acyclic motions. Furthermore, there is a need in the art for structures and methods for automatically generating motion cycle models from given acyclic motions.

The current state of the art does not include structures and methods for representing cyclic surface contact information associated with the feet of legged assemblies contacting the ground. Impacts in general are common, but the cyclic pattern of foot contacts with the ground is an important input to the physical simulation of assemblies moving cyclically, and correspondingly acyclically via a constructed cycle, as described above. Accordingly, there is a need in the art for structures and methods for creating, editing, and extracting from spatial motions the surface contact qualities and quantities, and incorporating them into a motion cycle model.

The current state of the art does not include tools and methods for viewing, specifying, and editing symmetries in motion models. Many drawing tools provide the means to mirror structural changes across a dimension, usually the x-dimension, to ensure the spatial symmetry of an assembly without the need to draw everything twice. In the domain of motion specification, symmetry is more complex because it may include a time- or phase-based component, and because the assembly elements associated with the symmetry may themselves not be symmetric. As examples, the swinging of two arms may be out of phase by 180 degrees, or more, or less. Since arm swing represents a counter-balance to leg swing, the symmetry associated with arm swing may have modifications of the swing of the longer and heavier of two arms differing from those for the shorter and lighter of the two arms. Further, and again because the arm swing is a counter-balance to let swing, modifications of arm swing corresponding to a symmetry associated with leg swing will differ from modifications of leg swing and vice-versa, not only in magnitude, in phase and other characteristics. Accordingly, there is a need in the art for structures and methods for specifying, generating, viewing and editing motion model symmetries, and the underlying motions to which they relate.

The current state of the art does not include cyclic models of actuation forces and torques associated with models of cyclic motion. Actuation models for the cyclic actuation of assemblies, corresponding to cyclic motion models, provide the basis for viewing, analyzing and editing actuations in the same way that the motion model provides those bases for the motion itself. Accordingly, there is a need in the art for structures and methods for viewing, analyzing and editing actuation cycles associated with articulated assemblies intended to more cyclically and correspondingly acyclically as described above.

Previous definitions have referred to motion cycle models for articulated assemblies. However, motions of non-articulated structures, for example facial muscles, would benefit from the same modification and analysis mechanisms defined for the motion cycle model, if they were similarly represented. Accordingly, there remains a need in the art for a system for defining motion cycle models corresponding to quantifiable motion characteristics of non-articulated structures.

The current state of the art includes the recording and playback of linear motion sequences. Whether generated by hand via an electronic marionette or motion captured, a motion sequence can be created for a particular assembly. This sequence is linear in the sense that it represents a single timeline of motion, to be replayed to regenerate the motion states of the original, or a similar, assembly. Branches in motion, for example transitioning from a walk to a run, are done in the current state of the art by blending the states in a walk stride with the corresponding states in a run stride. This has a limited value in creating a visually pleasing transition. Although the motion may be smooth, it has a very low probability of being physically correct because not physical properties aside from positional information are used in blending. Furthermore, the blending operation itself requires substantial computational resources, unlike the linear playback of either gait involved individually. A graph representing the possible paths through a set of motion cycle models can be generated by defining the branch points with allow transitions of sequence generation from one motion cycle model to another, and correspondingly modifying the motion cycle models to ensure that all possible pathways represent physically correct motions. This aggregation of motion cycle models, henceforth referred to as a multimodel, may be stored in the form of a collection of motion cycle models, i.e., basis function magnitudes and phases, plus the branch information which connects them into a graph. A multimodel stored in this form can be used to generate articulated assembly states based on which particular motion cycle model contained within the multimodel corresponds to the current generation state. A multimodel may also be stored as an elaborated set of all of the articulated assembly states the pathways through the multimodel graph may generate, plus the branch information which connects them into a graph, for a given generation frame rate. A multimodel stored in this form can provide articulated assembly states using a lookup mechanism similar to that used for current state of the art, i.e., linear, motion capture sequences, with a correspondingly low computational cost. Accordingly, there is a need in the art for structures and methods for generating, viewing, analyzing and editing branched and looped motion sequences, representing a repertoire or character motion in a form amenable to direct, i.e., low cost playback, where the branched and looped motion sequence graph is created using subsequences of motion from motion cycle models.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to the creation, analysis, and modification of motion specifications of articulated assemblies, such as robots, prostheses, and animated characters, and more specifically to the modeling of motions of articulated assemblies with rigid and/or flexible arbitrary shaped segments.

In accordance with an embodiment of the invention there is provided a method comprising:

incrementally creating in computer memory a representation of a motion cycle model corresponding to an incrementally defined arbitrary articulated assembly corresponding to the subject of an artistic or technical design;

viewing and modifying the elements and properties of the increments of a motion cycle model and their relationships to the increments in the definition of an articulated assembly which is the subject of that motion cycle model;

creating in computer memory, either manually or mechanically through the extraction of the properties of a given acyclic motion sequence, a representation of a motion cycle model one or more portions of which correspond to acyclic motions of interest;

viewing and modifying the properties and definitions of acyclic motion sequences and their relationships to each other as they relate to the definition of a motion cycle model;

creating in computer memory a representation of the type, magnitudes, and phases for contacts with a support surface during a motion cycle;

viewing and modifying the type, magnitudes, and phases of the elements contained in the representation of contacts with a support surface associated with a motion cycle model;

creating in computer memory a representation of existing or desired symmetries to be either temporarily or permanently associated with a motion cycle model;

viewing, analyzing, modifying and enforcing the elements and properties of symmetries specified, either temporarily or permanently, as part of a motion cycle model;

creating in computer memory a representation of an actuation cycle corresponding to the forces and torques determined to be or expected to be those required to cause a given articulated assembly to execute the motions defined in a given motion cycle model;

viewing and modifying the elements and properties associated with an actuation cycle;

creating in computer memory a representation of a motion cycle model relating to the elements and properties of a subject which is not an articulated assembly;

creating in computer memory a representation of a multimodel, a motion model comprised of a set of motion cycle models, plus branching information which connects those cycles, or portions thereof, into an overall graph of motions containing branches and loops corresponding to the possible motions of a subject articulated assembly;

viewing and modifying the elements and properties of a multimodel;

importing actuation cycle and multimodel specifications in whole, in part, or in combination from other systems as part of the creation process;

exporting in whole, in part, or in combination, actuation cycle and multimodel specifications in formats which can be re-imported by the present invention or by other systems.

In accordance with an embodiment of the invention there is provided a system comprising:

a microprocessor coupled to a non-volatile, non-transitory memory for establishing a control sequence

for controlling the articulated assembly; and

the non-volatile, non-transitory memory for storing data relating to the articulated assembly and

computer executable instructions which when executed relate to a process establishing the control

sequence, the process comprising the steps of:

incrementally creating in computer memory a representation of a motion cycle model corresponding to an incrementally defined arbitrary articulated assembly corresponding to the subject of an artistic or technical design;

viewing and modifying the elements and properties of the increments of a motion cycle model and their relationships to the increments in the definition of an articulated assembly which is the subject of that motion cycle model;

creating in computer memory, either manually or mechanically through the extraction of the properties of a given acyclic motion sequence, a representation of a motion cycle model one or more portions of which correspond to acyclic motions of interest;

viewing and modifying the properties and definitions of acyclic motion sequences and their relationships to each other as they relate to the definition of a motion cycle model;

creating in computer memory a representation of the type, magnitudes, and phases for contacts with a support surface during a motion cycle;

viewing and modifying the type, magnitudes, and phases of the elements contained in the representation of contacts with a support surface associated with a motion cycle model;

creating in computer memory a representation of existing or desired symmetries to be either temporarily or permanently associated with a motion cycle model;

viewing, analyzing, modifying and enforcing the elements and properties of symmetries specified, either temporarily or permanently, as part of a motion cycle model;

creating in computer memory a representation of an actuation cycle corresponding to the forces and torques determined to be or expected to be those required to cause a given articulated assembly to execute the motions defined in a given motion cycle model;

viewing and modifying the elements and properties associated with an actuation cycle;

creating in computer memory a representation of a motion cycle model relating to the elements and properties of a subject which is not an articulated assembly;

creating in computer memory a representation of a multimodel, a motion model comprised of a set of motion cycle models, plus branching information which connects those cycles, or portions thereof, into an overall graph of motions containing branches and loops corresponding to the possible motions of a subject articulated assembly;

viewing and modifying the elements and properties of a multimodel;

importing actuation cycle and multimodel specifications in whole, in part, or in combination from other systems as part of the creation process;

exporting in whole, in part, or in combination, actuation cycle and multimodel specifications in formats which can be re-imported by the present invention or by other systems.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary block diagram of the components of a cycle model according to an embodiment of the invention;

FIG. 2 depicts an exemplary block diagram of the components of a coordinating system for the incremental construction of a motion cycle model with the incremental construction of an articulated assembly according to an embodiment of the invention;

FIG. 3 depicts an exemplary motion cycle model constructed using a desired acyclic motion and variations of it according to an embodiment of the invention;

FIG. 4 depicts an exemplary diagram of heel and toe positions of an articulated assembly as provided by a motion sequence, which are used to infer the type, magnitudes and durations of contacts with a support surface according to an embodiment of the invention;

FIG. 5 depicts an exemplary view of a motion cycle model with integrated surface contact information according to an embodiment of the invention;

FIG. 6 depicts an exemplary block diagram of the components in a motion cycle model editing environment which hold and act on the symmetries specified for the motion cycle model according to an embodiment of the invention;

FIG. 7 depicts an exemplary non-articulated structure for which a motion cycle model can be defined according to an embodiment of the invention;

FIG. 8 depicts an exemplary block diagram of an actuation cycle according to an embodiment of the invention;

FIG. 9 depicts a multimodel as an exemplary lattice of cycle models showing ranges and points of egress and ingress for the connecting arcs in the graph according to an embodiment of the invention;

FIG. 10 depicts an exemplary set of motion cycle models which are the nodes in the lattice in FIG. 9 according to an embodiment of the invention;

FIG. 11 depicts a network environment within which embodiments of the invention may be employed; and

FIG. 12 depicts a wireless portable electronic device supporting communications to a network such as depicted in FIG. 11 and as supporting embodiments of the invention.

### DETAILED DESCRIPTION

This invention relates to the design and simulation of articulated assemblies, such as robots or animated characters, and more specifically to the model used to represent motions of such assemblies, and to the structures, systems and methods used to construct, view, analyze, and modify such a model.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) or “mobile electronic device” (commonly referred to as a mobile) as used herein and throughout this disclosure, refers to a wireless device used for communications and other applications that requires a battery or other independent form of energy for power. A PED may be recharged from a fixed interface to obtain power and also be connected to a wired communications interface. This includes devices, but is not limited to, such as a cellular telephone, smartphone, personal digital assistant (PDA), portable computer, pager, portable multimedia player, portable gaming console, a navigation system, laptop computer, tablet computer, a wearable device, an implanted device, a smart card, portable PoS, mobile PoS (mPoS), a motorized vehicle, a non-motorized vehicle, public transit vehicle, a vehicle guided by tracks and/or rails, an aircraft, a lighter-than-air device, a drone, a robot, an android, a biomedical device, an item of medical equipment and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a terminal, a gaming console, a digital set-top box, a base station, a wireless network access node/point, a network device, an automated teller machine (ATM), an automated banking machine (ABM), an analog set-top box, an Internet enabled appliance, an Internet enabled television, a PoS, a vending machine, a self-service device or system, a robotic system, an item of medical equipment, an entertainment system and a multimedia player.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook™, Google+™ Tumblr™ and Twitter™; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

A “computer server” (commonly known as a server) as used herein, and throughout this disclosure, refers to one or more physical computers co-located and/or geographically distributed running one or more services as a host to users of other computers, servers, PEDs, FEDs, etc. to serve the client needs of these other users. This includes, but is not limited to, a database server, file server, mail server, print server, web server, gaming server, virtual environment server, utility provider server, service provider server, goods provider server, financial server, financial registry server, personal server, and a Government regulatory server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED, FED and/or server.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility provider, a financial provider and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of service providers, members of a financial registry, members of utility providers, members of retailers, members of organizations, members of charities, men, women and children. In its broadest sense the user may further include, but not be limited to, software systems, mechanical systems, robotic systems, android systems, etc. that may be characterized by an ability to exploit one or more embodiments of the invention. A user may be associated with biometric data which may be, but not limited to, monitored, acquired, stored, transmitted, processed and analyzed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user profile information, and personal information. It may also include a user's biometric information, an estimation of the user's biometric information, or a projection/prediction of a user's biometric information derived from current and/or historical biometric information, and current-historical profile information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Biometric” information as used herein may refer to, but is not limited to, data relating to a user characterized by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odor, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List of file formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities.

“Geo-location” as used herein refers to, but is not limited, to the identification or estimation of the real-world geographic location of an object. In its simplest form geo-location involves the generation of a set of geographic coordinates and is closely related to the use of positioning systems, such as global positioning systems (GPS). However, other non-satellite based systems may be employed including for example geo-locating or positioning based upon a location engine exploiting wireless/radio frequency (RF) location methods such as Time Difference of Arrival (TDOA) where such information is accessible from multiple wireless transponders to allow triangulation. Alternatively, wireless base stations/cell towers can be employed to triangulate the approximate position through timing/power information of the multiple wireless base stations/cell towers which whilst subject to many sources of error beneficially supports indoor environments as well as outdoor environments where GPS satellite signals are weak or blocked. Other geo-location methods can include Internet and computer geo-location by associating a geographic location with the Internet Protocol (IP) address, MAC address, RFID, Wi-Fi access node etc. IP address location data can include information such as country, region, city, postal/zip code, latitude, longitude and time zone. Geo-location data may be defined in international standards such as ISO/IEC 19762-5:2008 or as defined by other standards or proprietary formats.

An “assembly” as used herein and through this disclosure refers to, but is not limited to, a combination of manufactured parts into a complete machine, structure or unit of a machine wherein the assembly comprises one or more segments which are coupled together via joints which have N degrees of freedom (0≤N≤6). The assembly may comprise actuators as segments (e.g. linearly extending segment), joints (e.g. motorised rotary joint), or actuators joining segments (e.g. a screw drive connecting two segments or a spring between two segments). An assembly may comprise elements such as wheels, tracks, etc. attached to segments at specific points including ends of segments etc. Examples of assemblies may include, but are not limited to, a bipedal android, a prosthetic hip replacement, an exoskeleton for a construction work, a robot with eight legs, a tracked vehicle, and a quadruped. Assemblies may be, but are not limited to, fully finished products in their own right, full simulations for direct viewing, a skeleton or exoskeleton of a product visualized with or without the body of the product, a mechanical representation of a human figure, a mechanical representation of an animal, and a mechanical representation of an imagined creature or vehicle.

“Terrain” (or relief or topographical relief) as used herein and through this disclosure refers to, but is not limited to, the vertical and/or horizontal dimensions of a surface upon which an articulated assembly moves through a fluid. Terrain accordingly, is used as a general term with respect to the physical geography, referring to the lay of the land, and is usually expressed in terms of the elevation, slope, and orientation of terrain features. Terrain may therefore refer to, but is not limited to, an area of land with air as the fluid, an area of the bottom of an ocean or other aqueous structure with water as the fluid, and an area of a surface from a solid or frozen material with a gaseous or liquid fluid.

A “segment” as used herein and through this disclosure refers to, but is not limited to, one of the parts (segments) into which something naturally separates or is divided. A segment may therefore be, but is not limited to, a division, a portion, or a section.

A “joint” as used herein and through this disclosure refers to, but is not limited to, a point at which parts of an artificial structure are joined. A joint may have N degrees of freedom (0≤N≤6) being within one frame of reference, X, Y, and Z linear axes together with roll, pitch, and yaw rotary axes around the X, Y and Z axes respectively. A joint may provide multiple axes within a single element or by combining several elements together. The X, Y, Z, roll, pitch and yaw axes for a joint may be renamed based upon their position and orientation within the articulated assembly.

A “physical law” (scientific law) as used herein and through this disclosure refers to, but is not limited to, a theoretical statement “inferred from particular facts, applicable to a defined group or class of phenomena, and expressible by the statement that a particular phenomenon always occurs if certain conditions be present.” Physical laws are typically conclusions based on repeated scientific experiments and observations over many years and which have become accepted universally within the scientific community. Such physical laws may include, but are not limited to, conservation of energy, conservation of momentum, conservation of angular momentum, conservation of mass, hydrodynamic continuity equation, gravity, and laws of motion (e.g. Newton, Euler).

“Motion” as used herein and through this disclosure refers to, but is not limited to, a change in position of an object over time. Motion may be described in terms of displacement, distance, velocity, acceleration, time and speed. Motion of a body is typically observed by attaching a frame of reference to an observer and measuring the change in position of the body relative to that frame.

A “combined motion” as used herein and through this disclosure refers to, but is not limited to, the coordinated motion of a set of assembly segments, where the set is identified, and it's quantifiable properties such as absolute and relative magnitudes and phases of the motions of segments or subsets of elements are defined. A combined motion may be given a name to relate it to identical or similar motions of a second assembly.

A “characterization” as used herein and through this disclosure refers to, but is not limited to, the assigning of a mental inclination or an emotional state to a given motion, combined motion, or motion model. A characterization may be quantifiable, or may be marked as either being present or not. A characterization may be given a name to relate it to identical or similar properties of a second assembly or motion model.

A “basis function” as used herein and through this disclosure refers to, but is not limited to, a periodic time-domain function. One property of a basis function is its shape: it may be smooth, like a classic trigonometric sine or cosine, or angular, like a square wave or a saw-tooth wave. A second property of a basis function is its magnitude, measured either from a zero- or mid-line, if symmetric, or from its minimum extreme to its maximum extreme. A third property of a basis function is its phase, measured either with respect to a defined point such as a zero crossing, or with respect to a defined point in another basis function, in which case the phase measurement is relative to that other basis function.

“Fourier Analysis” as used herein and through this disclosure refers to, but is not limited to, a method for representing a complex waveform as a series of basis functions. Basis functions are typically sinusoidal functions, but can be any period shape. The frequencies of basis functions used to represent a complex waveform typically form a harmonic series, but can be any sequence of frequencies.

The present invention defines i) a structure and methods for containing and specifying complex cyclic motions as sets of related basis functions, with different periods, magnitudes and phases, ii) systems and methods for viewing, analyzing, and modifying such motion specifications at the level of basis functions, iii) systems and methods for viewing, analyzing, and modifying such motion specifications at the level of coordinated combinations of element motions, iv) systems and methods for viewing, analyzing, and modifying such motion specifications at the level of motion characterizations, and v) systems and methods for generating actuation and motion sequences for articulated assemblies from such a motion specification.

Motion Cycle Model

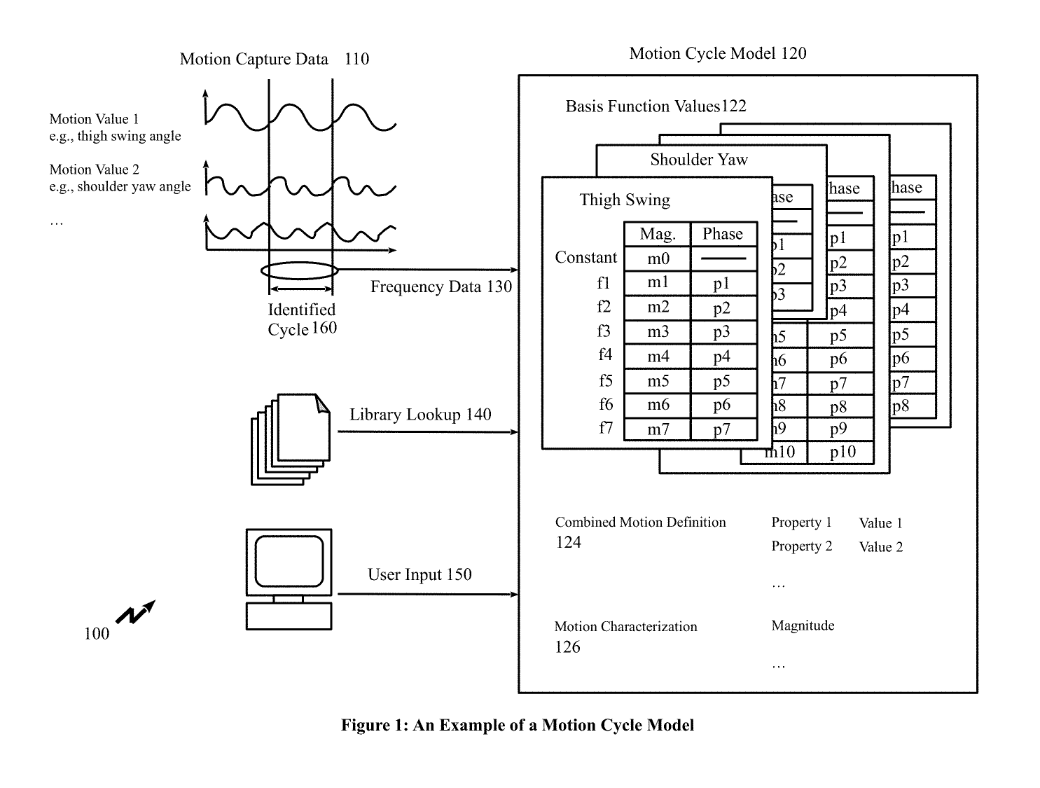

Referring to FIG. 1 there is depicted a block diagram of an embodiment of a motion model (MoMo) 100. The MoMo 100 is comprised of a set of elements corresponding to attributes of motion associated with particular assembly elements. As depicted such attributes are Motion Capture Data (MoCaDa) 110 within this exemplary embodiment wherein examples of degrees of freedom are i) the thigh swing attribute of the left leg element of an assembly representing a humanoid, and ii) the yaw attribute of the shoulders element of an assembly representing a humanoid. The motion attribute is comprised of a set of magnitudes and phases of basis functions associated with the assembly element. The embodiment of the invention depicted shows different numbers of basis functions for different attributes.

In FIG. 1, the paths from the MoCaDa 110 curves representing an example motion-captured frame sequence are shown as a way to initialize a motion model. Based upon analysis of the MoCaDa 110 an identified repetitious or pseudo-repetitious cycle is identified, Identified Cycle 160. This identified cycle 160 may then be subjected to frequency analysis, for example, yielding Frequency Data 130 which is then entered as part of the MoMo 120 as depicted by Basic Function Values 122. Other alternatives are to load a existing motion model from a library, Library Lookup 140, or to create a motion model from a blank state by either loading or defining an articulated assembly model, then assigning motions to its elements either by dragging it as a marionette or by inputting curve values, e.g. User Input 150.

Accordingly, in addition to the Basic Function Values 122 the MoMo 120 may also contain Motion Definition 124 and Motion Characterization 126, for example. The motion specification in the MoMo 120 can be converted back to pose information for an articulated assembly, i.e., values for absolute and relative positional, and for joint degree of freedom values, by i) directly setting those values, when direct values are defined to be part of the motion model, or ii) deriving those values using known techniques of forward and inverse kinematics, when indirect values are defined to be part of the motion model. Examples of direct values are i) the absolute height of the assembly's root segment above a support surface, and ii) an angle value for a particular joint degree of freedom. Examples of derived or indirect values are i) the absolute center-of-mass of the assembly, which is an aggregated value depending on all of the assembly's massive elements, and ii) the angle of the forearm with respect to the ground, which is related to, but not equal to the angle of the elbow joint's one degree of freedom. Assembly positional values are computed from the motion model curves for regular phase intervals over the cycle represented in the model, at an interval size corresponding to the speed at which the cycle is to be executed, and the desired output frame rate. Positional value computation can continue beyond the duration of the cycle in the MoMo 120 by repeating that cycle indefinitely to produce a continuous, period motion of the subject articulated assembly.

The MoMo 120 may represent the motion of an entire articulated assembly, or a portion thereof. For example, one MoMo 120 may represent the motion of legs walking, while a second MoMo 120 may represent the motion of arms swinging. Those MoMo 120s may be extracted and/or created independently of each other and of the other elements in the assembly, and the poses representing the motion of the entire articulated assembly, including arms and legs, may be formed by combining pose computations from the two models.

Additionally, a desired motion from an artistic or compositional point of view may involve coordinated combinations of motions of individual elements, which will be referred to as a combined motion. An example is a pirouette, which represents the coordinated motions of arms and legs at different degrees of synchronization or opposition and at offsetting amplitudes, in total defining a motion that is physically correct and/or visually pleasing. A simpler example is the swinging of arms, which involves the coordinated motions of shoulder, arm and hand elements to provide a physically plausible and/or visually pleasing overall motion. As for basis functions, combined motions can be quantified in a number of ways. Examples of quantifiable elements are i) the speed of execution, ii) the magnitude of the overall motion, and iii) the relative magnitudes and phases of the elements of the motion.

A MoMo 120 may contain zero or more named combined motion definitions, such as depicted by Motion Definition 124 in FIG. 1 The quantification values for the quantifiable elements of each combined motion definition may be derived from segment motions defined via basis functions in the model, or set as reference values for use in evaluating corresponding combined motions in other motion models.

Additionally, where an assembly is meant to represent a creature of complex inner state, such as a human, an animal, an alien, or a mechanical automaton, a motion involving some or all of an assembly's elements may relate to an emotional state or a mental intention ascribed to the represented creature. A given motion might then be characterized as, for example, an angry motion, a fatigued motion, or a joyful motion. Such characterization are common in libraries of motion captured sequences, which are simple recordings of motion, not parameterized models.

A MoMo 120 may contain zero or more named characterizations, such as Motion Characterization 126 in FIG. 1. The magnitudes of the characterizations may be derived from motion or combined motion values, or set as reference values for use in evaluating corresponding characterizations in other motion models.

Incremental Motion Model Creation

A typical application for designing an articulated assembly would allow for incrementally adding, removing, or modifying elements. Those elements vary in complexity. An increment of change could be, for examples, i) a segment property, ii) a segment, iii) a segment and a joint, or iv) a sub-assembly containing a number of segments and joints, such as an arm or a leg.

To create and maintain a consistent motion model for an assembly as the assembly is designed, an embodiment of the current invention would add, remove, or modify motion model elements corresponding to added, removed, or modified assembly elements. Examples of such complementary changes are:
1) Modifications Involving Direct Correspondences This is the case when a motion model contains an element directly corresponding to the assembly element being modified. An example is an assembly property which represents the range of motion of a degree of freedom of an assembly joint, and a motion model property associated with the angle or displacement of the given degree of freedom of the given joint. At the time that a change is made to the range of motion of the joint degree of freedom, or at a later time, possibly triggered by a human action, the curve representing the joint angle or displacement in the motion model would be examined. If the joint angle or displacement exceeds the new limit at any time during the cycle, the motion model would be corrected by limiting the value of that angle or displacement, i.e., modifying the curve representing that element of motion, generating a sequence of assembly states based on the modified motion model, and then re-extracting the motion model using the methods previously described for extracting motion model parameters from a motion sequence.
2) Modifications Involving Indirect Correspondences This is the case when a motion model contains one or more elements not directly corresponding to the assembly element being modified, but whose values change when that assembly element is modified. An example is the angle between segments representing the left and right halves of the pelvis which, when modified, causes changes of the positions of the legs attached to that pelvis, where, for example, the angle of the shin with respect to the vertical is a parameter represented in the motion model. After a modification of the pelvis joint, the limitation of the knee to, for example, not be able to bend backward make make it impossible for the shin angle specified in the motion model to be achieved for some or part of the motion cycle. In this case, the motion model would be corrected by generating a sequence of assembly states based on the modified motion model, limiting the degree to which the shin angle is achieved based on the knee constraint, and then re-extracting the motion model using the methods previously described for extracting motion model parameters from a motion sequence.
3) Additions When a leg is added to an assembly, for example, a corresponding set of elements can be added to the motion model. The set of motion model elements may be one of a number of possible sets of motion model elements for a leg, where the alternatives depend on the type of leg added, e.g., forward or backward bending knee, and/or on what templates are available for a leg of a given design. The added motion model elements may be initialized i) with no information, essentially filled with zeroes, ii) using values stored in a template, or iii) using values from other legs already part of the assembly-motion model system.
4) Deletions When a leg is removed from an assembly, for example, the corresponding elements in the motion model are removed in order to maintain the applicability of the motion model to the assembly. This may be done virtually by simply ignoring motion model elements which refer to non-existent assembly elements at the time that motion sequences are generated.

Changes made to the motion model in response to changes in the assembly could be done i) immediately as individual changes to the assembly are made, ii) as a group when, for example, the user or controlling system takes some action which changes the focus of their activity away from assembly modification, or iii) at the time of, and not before, an explicit request by the use or controlling system to do so.

An embodiment of the invention may also, or alternatively, modify an assembly in response to modifications to the motion model. Referring to the cases listed above, in 1) a range of motion in the specification of a degree of freedom of a joint may be expanded if the motion model is modified in such a way as to increase the position of that joint beyond the current limit, in 2) a fixed pelvis joint angle may be modified in response to a motion model change to a shin angle which cannot be achieved with the current pelvis joint angle, and in 3) and 4) the addition or deletion in whole or in part of a set of motion model elements corresponding to a leg may result in a leg being added or deleted from the assembly.

In all cases, a user or controlling system may be consulted before the change they are requesting is applied, where that consultation may indicate the corresponding changes to other elements which will result from the change being requested, and/or alternative choices of changes to other elements which will maintain the consistency of the system.

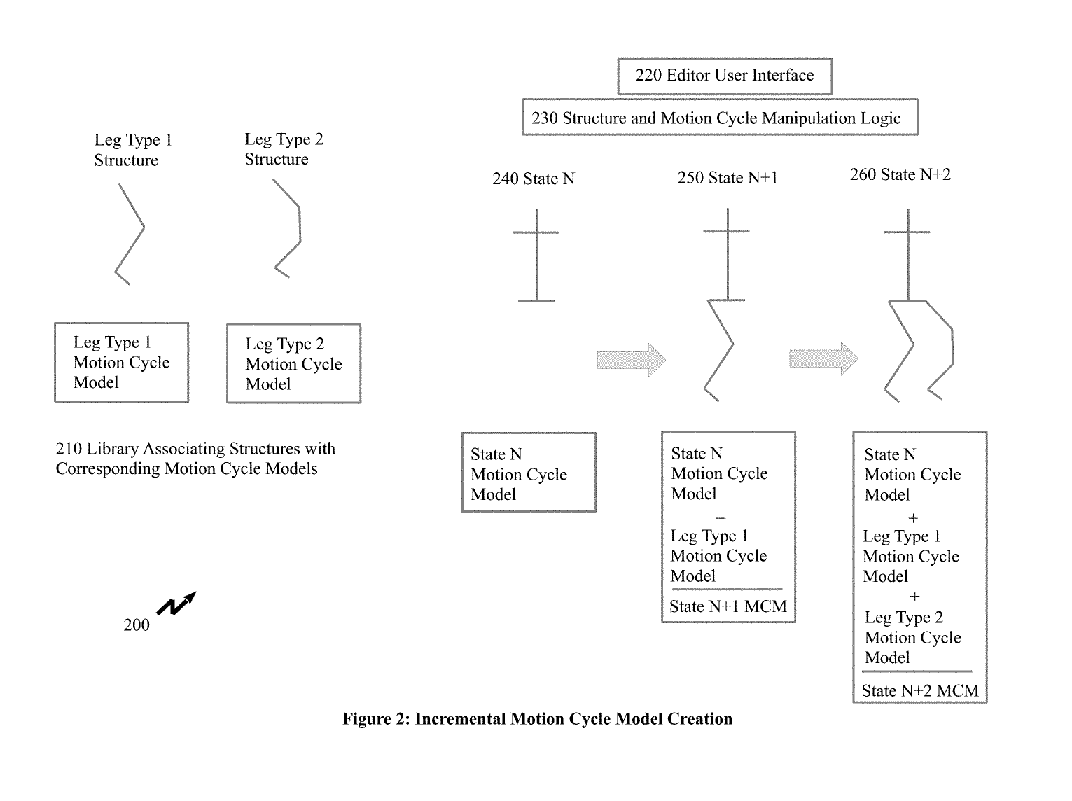

Referring to FIG. 2 there is depicted a block diagram 200 of the components of an embodiment of the invention. The Library 210 component holds a set of structures representing subassemblies, in this example legs, to be added to an articulated assembly along with associated motion cycle models for those sub-assemblies. Via the Editor User Interface 220 component, the user expresses a desire to add a sub-assembly to the current structure as a particular point of attachment. In response, the Manipulator 230 adds the sub-assembly to the current structure and also adds the motion cycle model for that sub-assembly to the current motion cycle model for the assembly under construction. Alternatively, the user may express a desire to add a motion cycle model to the current model state as a behavior. In that case, the motion cycle model is added to the motion cycle model for the assembly under construction and the corresponding sub-assembly from the Library to the assembly under construction. Different embodiments of the invention will add the sub-assembly at i) a random point, ii) a heuristically determined point corresponding to the nature of the sub-assembly and the state of the assembly under construction, or iii) at a point chosen by the user when prompted.

In FIG. 2, the construction state of the assembly goes from State N 240 with no legs, to State N+1 250 with one leg of type 1, to State N+2 260 with one leg of type 1 and one leg of type 2. The motion cycle for each leg is added to the motion cycle for the assembly under construction as the leg structure itself is added for States N, N+1 and N+2, respectively.

Motion Cycle Model for Acyclic Motions

A cyclic model may be created by concatenating acyclic motions. The purpose of creating a cyclic model is to make use of the same authoring, viewing, analyzing and editing tools for both types of motion. In particular, acyclic motions, for example a transition from walking to running, may be authored or captured in isolation and may be inconsistent with the walking and running motions it is intended to transition between. A cycle containing in part such a transition allows the frequency content, positional information, speeds, accelerations and other properties to be manipulated in order to match the corresponding properties of the walk and run.

As an example, it may be desirable to have a character transition from walking to standing. Such a transition might:
1) begin with the articulated assembly in a state corresponding to the extension of its stride with the left foot planted and the right foot extended forward, and the center of mass moving at some velocity in a direction from the left foot to the right foot,
2) plant the right foot at that extended position, where the assembly will come to a standing rest,
3) lift the trailing left foot and support the character on the right foot as the left foot sweeps forward toward it,
4) decelerate the assembly's center of mass via a backward force from the right foot as the left foot approaches its position,
5) bring the left foot into contact with the ground beside the right foot,
6) decelerate the assembly's center of mass to zero velocity as it comes over the feet.

To form a complete cycle, the above sequence might be continued as follows:
1) from the standing position, the right foot is lifted,
2) via a backward force on the left foot, the right foot and the assembly's center of mass are accelerated forward along the same path that the assembly followed in going from walking to standing,
3) continue the acceleration and extension of the right foot until the fully extended position that was the original starting position i) is reached.

The sequence from 1) through 6) then 1) through 3) forms a repeatable cycle, with the elements of the articulated assembly in the same relative positions and velocities in those states.

As another example, a variation on the example above would be to have the forward extended foot turned at an angle, corresponding to the angle of turn the character will make as it comes to rest or begins walking from rest. Corresponding changes are made to the angles, forces and torques involved in the example above, with the same intention of creating a cycle from an acyclic motion, in this case an acyclic motion which is a stopping turn or a starting turn, as a human would do if standing facing one direction and beginning a walk toward a target not directly ahead of it, or walking toward a target position and turning to face a particular object when coming to a stop.

Embodiments of the present invention may also contain methods for automatically generating cycles from acyclic segments:

Given an acyclic sequence of either position or actuation, it is desirable to create a cycle model representation, which can be done on the basis of repeating, reversing, and mirroring the acyclic sequence to create a cyclic sequence and then extracting a cycle model from that. A similar process can be used to represent acyclic actuations in a cyclic actuation model.

The previously described process implied a human designer specifying how variations of the provided acyclic sequence could be concatenated to for a complete cycle, i.e., with beginning and ending positions and motion derivatives equal. Embodiments of the current invention could automatically generate a cyclic sequence of either positional or actuational information and extract a cyclic model from that sequence. The method for generating a cyclic sequence from an acyclic sequence may be one of, or combinations of the following:

Matching the acyclic sequence to patterns in existing cyclic sequences to find similar cases. This method may include choosing some number of nearest matches and presenting them to a user or controlling system which will choose one of them.

Providing a graphical or textual environment in which a user can manipulate copies and/or variations on the given acyclic sequence, possibly adding arbitrary elements, to form a cyclic sequence. And

Generating a set of variations on the given acyclic sequence, such as reverses and mirrors, and doing an exhaustive or heuristic search through the possible concatenations of those sequences to find any cases which are cyclic. As in 1), this method may generate multiple alternatives from which a user or controlling system can choose.

The acyclic sequence may represent the motion or actuation of the entire articulated assembly with which it is associated, or it may represent the motion or actuation of a portion of that assembly, in which case the resulting cycle sequence and cycle model apply to corresponding portions of the assembly.

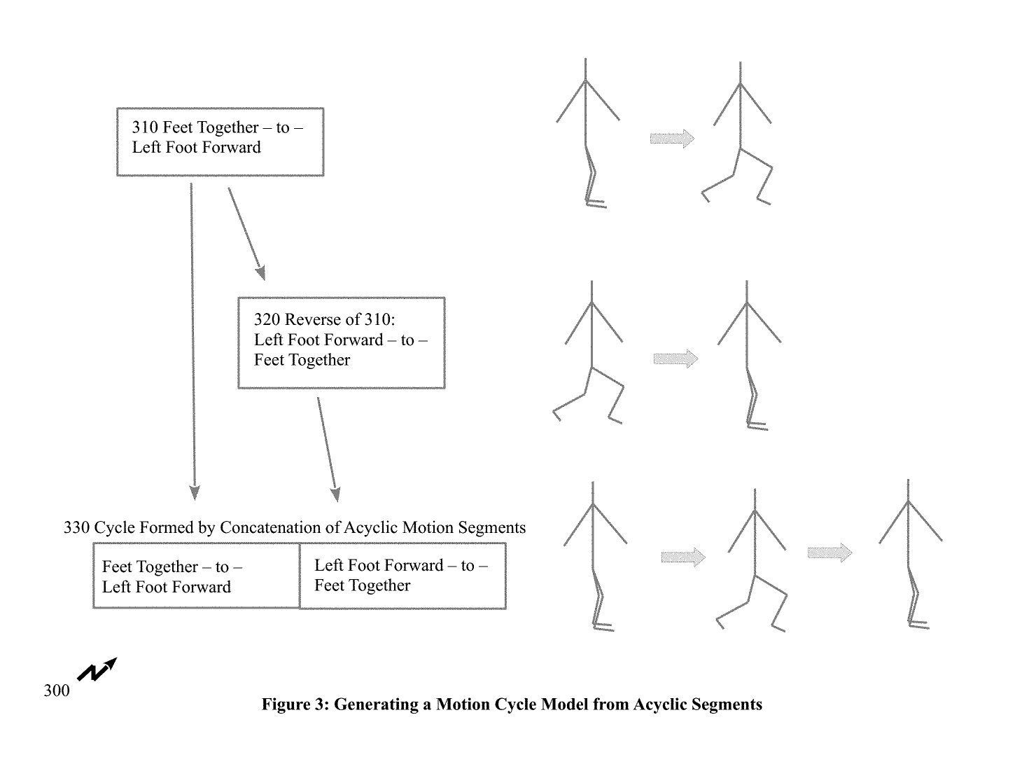

Referring to FIG. 3 there is depicted a block diagram 300 of the components of an embodiment of the invention. An acyclic motion 310 Feet Together-to-Left Foot Forward is a motion stored in a standard form, e.g., a sequence of assembly states. A graphical representation of the transition 310 from standing to walking is shown in the Figure. As directed by a user or automated system, a motion cycle model is to be generated which will contain, as a portion of it, acyclic motion 310. In this example, a reverse acyclic motion is defined by reversing the sequence of states in the given motion 310, i.e., acyclic motion 320 Left Foot Forward-to-Feet Together. A complete cycle 330, i.e., a sequence which begins and ends in the same state, is formed by concatenating the sequences for 310 and 320. A motion cycle model for the sequence 330 can now be extracted using frequency analysis of the properties of the state sequence, as described elsewhere.

A motion cycle model defined as illustrated in FIG. 3 can now be viewed, analyzed, and edited as any other motion cycle model, and portions of it corresponding to the given acyclic motion or its reverse can be incorporated into a complex motion sequence by, for example, generating a sequence to extend an assembly's left foot forward from a rest position where both feet are together, following that with some number of walking cycles, and following that with a sequence which starts with the left foot extended forward and ends with the feet together, i.e., with the assembly back in its rest state.

Embodiments of the invention may provide additional and alternative functions for request by a user. An embodiment may also satisfy a request to produce the mirror motion cycle model with respect to given acyclic motion. In such case, the state sequence corresponding to acyclic motion 310 is mirrored according to a symmetry defined for articulated assemblies to which it may be applied, and that sequence is then reversed, followed by a concatenation of the two newly defined sequences to produce a motion cycle, and subsequently a motion cycle model. In this mirrored case, a Feet Together-to-Right Foot Forward sequence, and its reverse, are defined, resulting in a motion cycle model for the extension of the right foot to begin a walk, and the planting of the left foot to terminate a walk.

Contact Information

The present invention provides a set of methods comprised of:
1) extracting cycle period information from a given motion-captured sequence,
2) extracting external contact information from a given motion-captured sequence,
3) creating in computer memory a representation of the external contact information associated with elements of an articulated assembly for which a motion model has been or is being defined, and
4) viewing and modifying elements, classifications and properties of external contact information for a motion sequence of an articulated assembly, either independently or as part of a motion model.

In the case where a motion capture sequence is the source of motion information, contact information may be extracted using the following method:
1) elements of the articulated assembly involved are identified. This may be done using i) pre-defined names for the segments, i.e., bones, in the skeleton defined in the motion capture file, ii) heuristics based on structural expectations, and assumptions about the assembly, such as it being an upright human, or iii) user input to map the segments to a prototype human skeleton,
2) identifying elements and points on elements that are expected to come into contact with external surfaces. Sources for this operation are as for 1). The elements may be, for example, the heels and toes of two feet,
3) track the motions of the assembly elements to determine the fundamental frequency of motion. This may be done by extracting the relative forward and backward positions of the heels of the feet involved, and then using known methods of frequency analysis, e.g., a Fourier transform, then choosing the frequency component of the highest magnitude, possibly using heuristics or human input to ensure that the correct frequency element is chosen. Such heuristics or input might include an expected range of values consistent with human walking, if the subject is a human walker, for example,
4) derive from the heel and toe motions lateral motion values as functions of time by, for example, doing frame-by-frame differences of lateral position,
5) use the vertical height and lateral motion information for the heels and toes of the feet in combination with the fundamental frequency of the motion to infer contact with an external surface, in this example the ground. This is done by extracting the intervals over which a given contact point, e.g., a heel, is within a threshold vertical distance of its lowest altitude, and does not move laterally beyond a threshold value. Threshold values may be set as defaults or input by a user,
6) using known methods for eliminating noise, such as when debouncing the signal from an electrical switch, to smooth the contact intervals,
7) match the contact patterns with known contact patterns for particular contact types, for example a heel-to-toe walk or a skipping walk, and choose the most likely contact type, or allow a user to choose a contact type,
8) codify the contact information as a contact pattern of the most likely or chosen type, and as a sequence of contact events and intervals, e.g., left heel impact at time t0, left heel alone in contact for interval i0, left toe impact at t1, left heel and toe contact for interval i1, and so on.

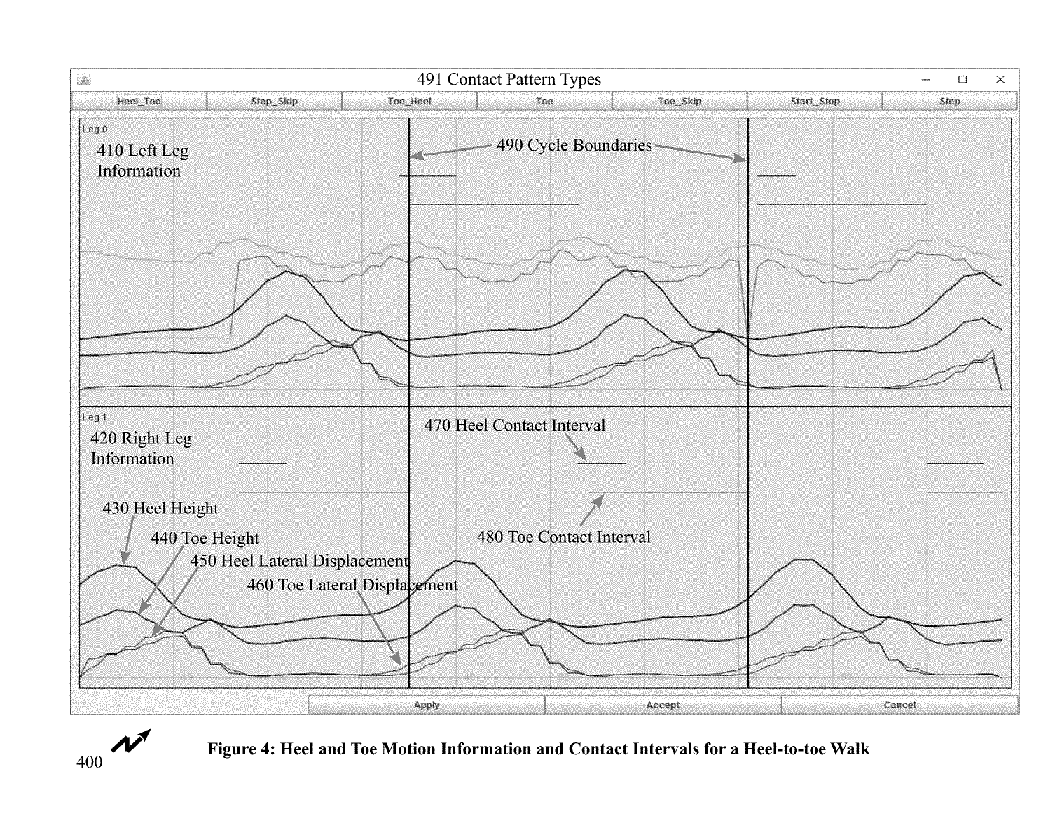

FIG. 4 shows a screen capture of one view of the current invention. The figure shows a window displaying a specific subset of information directly from and derived from a motion capture file for a human performing a casual walk. The top portion of the graph shows the information for Leg 0, e.g., the Left Leg 410 of the assembly; the bottom portion of the graph shows the information for Leg 1, i.e., the Right Leg 420 of the assembly. Referring to the Right Leg information, each graph area shows the Heel Height 430 above the support surface and the Toe Height 440 above the support surface over time. Additional graph lines show the frame-by-frame lateral motions of the Heel Lateral Displacement 450 and the Toe Lateral Displacement 460 for the given foot. Straight horizontal line segments show the inferred contact intervals for the heel and toe in black, the Heel Contact Interval 470 and in blue, the Toe Contact Interval 480. These contact intervals are inferred from the relative lowness of the heel or toe with respect to the maximum height they achieve from the support surface, in combination with coincident zero or near-zero lateral motions, using known methods of thresholding and cluster recognition.

The two thick vertical lines, the Cycle Boundaries 490, show the boundaries of the inferred walking cycle. The separation of the boundary lines represents the duration of the cycle of the walking stride, that inferred from the fundamental frequency of the motion. The positions of the boundary lines on the timeline correspond to lining up the cycle with a particular event in the cycle of contact, in this example the release of the toe of one foot from its contact with the ground through to the subsequent release of that toe from the ground after one full walking cycle stride. The duration of the cycle is inferred using known method of frequency analysis to determine the base frequency of the foot motion. An embodiment of the invention may allow for user input to aid the detection of the cycle duration from the extracted frequency information. An embodiment of the invention may provide the means for a user to indicate the type of foot contact pattern the foot motion represents as further input to the contact interval extraction methods, as shown with the line of buttons Contact Pattern Types 491 in the figure.

Furthermore, after automated extraction of contact intervals and cycle boundaries, an embodiment of the invention may allow a user to modify the type and durations of the states and events in the contact pattern. This may be done either through a manipulation, e.g., dragging, an element in the graphical user interface, or through a manipulation of the qualitative and numeric values in a textual or a non-graphical computer memory representation of the contact pattern.

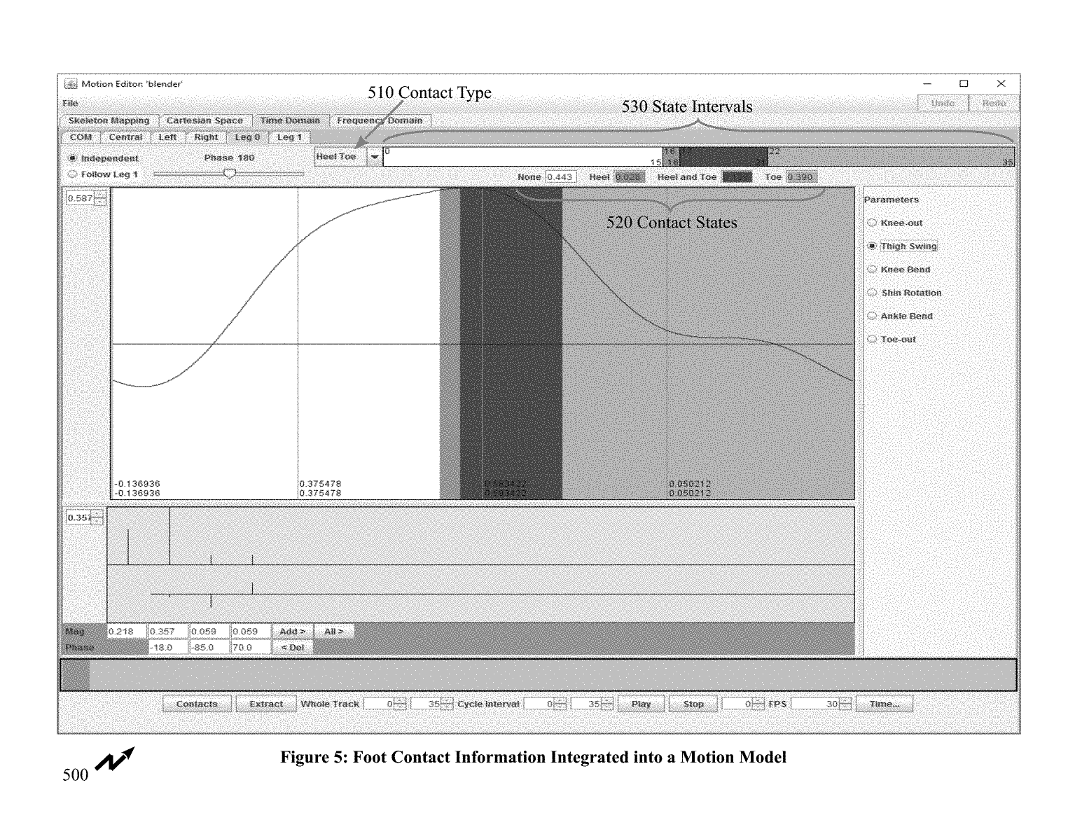

FIG. 5 shows a screen capture of the motion model editor where foot contact information has been integrated into the cycle information. The motion of leg 0 in the example includes the contact classified as “Heel Toe”, Contact Type 510, indicating a normal human walk, and shows Contact States 520 and the State Intervals 530 between those events on a separate timeline and the timeline used for graphing another part of the leg motion, in this case the swing of the thigh. Intervals are shown as fractions of the whole cycle, and as frame ranges for a given number of frames for the whole cycle.

An embodiment of the invention may use an indication of the type of contact pattern from a user via a user interface. As an example, the pattern may be Heel-Toe, i.e., the heel of one foot contacts the support surface first, followed by the toe of that foot contacting the surface, followed by the heel disengaging from the surface, followed finally by the toe disengaging from the surface, with the contacts for one foot alternating with the contacts for the other foot.

An embodiment of the invention may instead infer the type of contact pattern using known methods of closest-fit to choose a pattern from a candidate set that most closely matches the heel and toe contact intervals established through the analysis of foot motion described above.

Again referring to FIG. 5, as for other elements in the motion cycle model, an embodiment of the invention allows a user to view, analyze, and modify the properties of the foot contact portion of the model.

Symmetry Specification and Maintenance

Embodiments of the model editor may include features for managing and enforcing symmetry across the cycle of motion of an articulated assembly.

When editing a character skeleton or mesh, various tools provide symmetry management and enforcement facilities for structural elements. For example, a character may be designated to have bilateral symmetry. If so designated, a change made to the left side of the character, for example, will be duplicated on the right. As a more specific example, if a character is being designed and a leg is added and edited on one side, a mirror image of that leg is created and modified automatically on the other side.

The current invention provides methods for extending the facilities for managing and enforcing symmetry to the time domain, in the context of a motion cycle. If it is desirable for a portion of a motion model to be symmetric:
1) the elements across which the symmetry is to be enforced are identified. For example, the two legs of a symmetrically defined biped may be identified as elements that should move symmetrically,
2) the plane across which the motion should be symmetric is identified. In the case of a time-based motion cycle, the plane may be an absolute phase value in the cycle, or a relative phase difference within the cycle such as the phase difference between the motions of the symmetric elements. In the example of the biped walk, the legs may be identified to be move 180 degrees out of phase with each other. If these were two legs of a four-legged character, such as the hind legs of galloping a horse, the two legs may be identified to move symmetrically, but out of phase by something somewhat less than 180 degrees,
3) the type of symmetry is identified; the motion may be identical or mirror-symmetric. An example of an identical symmetry is the lift of the foot during a stride; both feet are to rise the same amount as they go from being in contact, rise to a maximum as the leg swings forward, and descend back to the ground. An example of a mirror-symmetric symmetry is the angle of the left and right foot out of the sagittal plane as the character walks; the angles may be designated to be of the same magnitudes over the course of the cycle, separated by, for example, 180 degrees, but the left toe may point out to the left while the right foot points out to the right,
4) as modification are made to the motion of one of the two elements designated to move symmetrically, the corresponding changes are made to the motion cycle for the other.

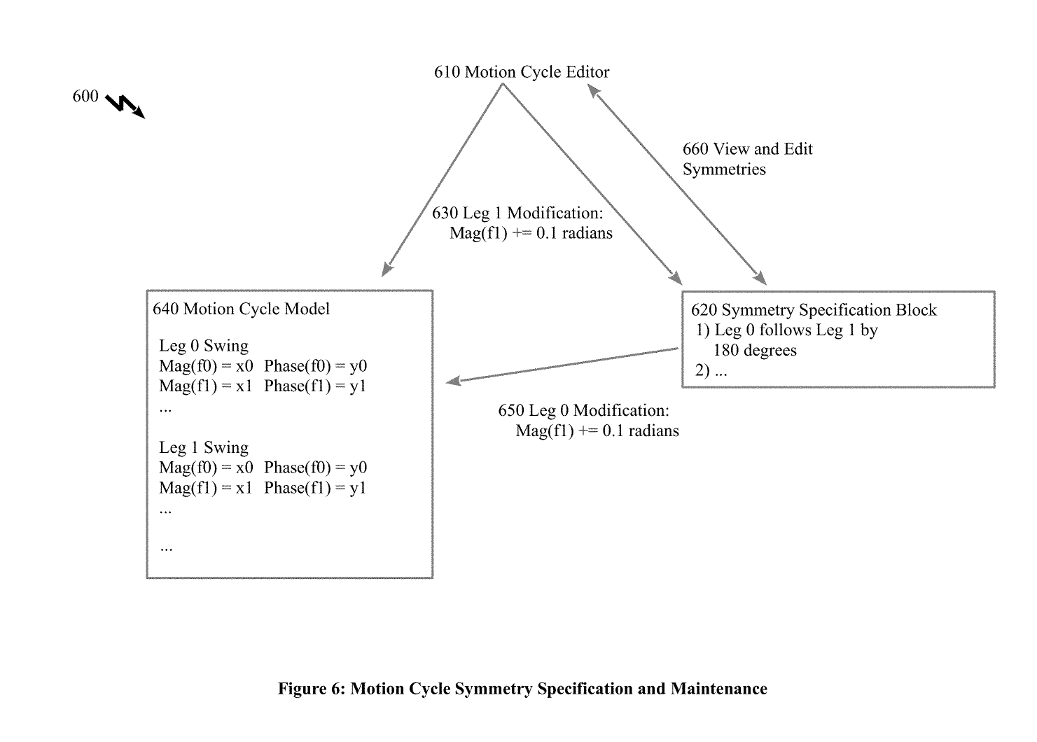

Referring to FIG. 6 there is depicted a block diagram 600 of the components in a Motion Cycle Editor 610 for storing and operating on symmetry information associated with the motion cycle model. The Symmetry Specification Block 620 holds information about the symmetries in the model, and the methods for maintaining those symmetries. An embodiment of the invention may operate in the following way:
1) When a signal indicating that an element in the motion cycle model is to be modified 630 arrives,
2) that element is changed in the Motion Cycle Model 640, and
3) the signal is also sent to the Symmetry Specification Block 620, and
4) where the Symmetry Specification Block determines that a symmetry will be broken by the element change, it modifies other elements in the motion cycle model as indicated by Modification 650 to re-establish the symmetry.

An embodiment of the invention may allow for the specification of a symmetry between the arms of an articulated assembly, i.e., that they will swing with the same magnitude and with a 180 degree difference in timing. In that case, if the swing of one arm is changed, the swing of the other arm is changed to maintain the symmetry.

An embodiment of the invention may allow for physical rather than spatial symmetries. For example, the symmetry expressed may be that both arms of a two-armed assembly must present the same moment of inertia in order that a pirouette of the assembly may be property executed. In that case, a change in the spatial motion of one arm may result, through the symmetry maintenance, in a somewhat different change in the spatial motion of the other arm such that the moment symmetry is maintained.

Motion Cycle Models for Non-Articulated Structures

Non-articulated structures are structures with parts that move or change shape, but do not necessarily contain rigid or semi-rigid segments and joints which are the basis for defining articulated assemblies. Example of non-articulated structures are a human face, an octopus and an elephant's trunk.

For articulated assemblies with rigid segments, a 4×4 matrix is sufficient to record the positional information of a segment, one per segment is sufficient to record the entire positional information about the assembly. For articulated assemblies with semi-rigid segments, the requirement is slightly higher in that some deformation value or values must be added for each segment to completely record the positional information about the assembly.

For non-articulated assemblies, the points used to record positional state are not as clearly defined. One alternative is the use of a regular grid or lattice whose crosspoints can be used to track deformations. The grid or lattice may be shaped to coincide with the surface of the subject, it may be aligned with an axis coordinate system, or a combination of the two could be used, for example a 3-D regular lattice through the bulk of the subject plus a 2-D grid over the surface of the subject. A second alternative is an irregular grid or lattice, i.e., one whose crosspoints are more closely spaced in some areas than in others. More closely spaced crosspoints would be used in areas where subject deformations are typically or are expected to be more closely spaced and/or more rapidly changing. For example, a widely spaced grid may be sufficient to capture the information about a cheek of a face, but a tightly spaced grid may be necessary to capture the relevant information about the lips. A third alternative is a set of defined points on and/or in the subject, these either being chosen by a human user, or inferred from observations of deformations over time.

One embodiment of the invention would gather positional information about a non-articulated assembly as follows: A rest position for that assembly is chosen. The rest position can be any arbitrary position, but would normally be chose as a state of zero tension or zero energy expenditure. In the rest state, the grid or lattice crosspoints are connected to surface and bulk point in the assembly using known binding techniques. As reference, this is the same techniques used to bind an animated character mesh to a skeleton using deformation weights in animation tools like Blender. With weighted connections established, a deformation of the assembly will result in displacements of the grid or lattice crosspoints. The set of deformation vectors, in either spherical or Euclidean form, for all crosspoints represents a complete set of positional information for the assembly with respect to the rest state.

A sequence of positional information for a non-articulated assembly in this form can be analyzed and represented as a cyclic motion model in the same way that a sequence of parameter values for an articulated assembly is, or the way a sequence of actuation information is, i.e., using a frequency analysis of each position parameter over the duration of an identified cycle to compute magnitudes and phases for a set of basis functions.

In the form of a cycle model, a non-articulated assembly motion cycle model can be analyzed, manipulated and otherwise used in the same variety of ways that any of the other cycle models can. Further, by inferring actuators at each grid or lattice crosspoint associated with the assembly, an actuation cycle model for a non-articulated assembly can be computed in the same way as for an articulated assembly. One embodiment of the invention would infer actuators as a set of three linear displacement actuators aligned with the axes of the chosen 3-dimensional space, each connecting a given crosspoint to a fixed value for that dimension corresponding to the rest value for that crosspoint.

To fully treat the non-articulated assembly as a physical system analizable on the basis of a structure, a motion model, and an actuation model, the properties of the material or materials it is composed of must be specified. These properties would include densities and elasticities, from which partial masses, spring constants, and damping factors can be calculated and used in calculations using know techniques in the field of finite element analysis.

As for articulated assemblies, physical properties of the non-articulated assembly material or materials can be inferred from structure, motion and actuation information.

Non-articulated structures are structures with parts that move or change shape, but do not necessarily contain rigid or semi-rigid segments and joints which are the basis for defining articulated assemblies. Example of non-articulated structures are a human face, an octopus and an elephant's trunk.

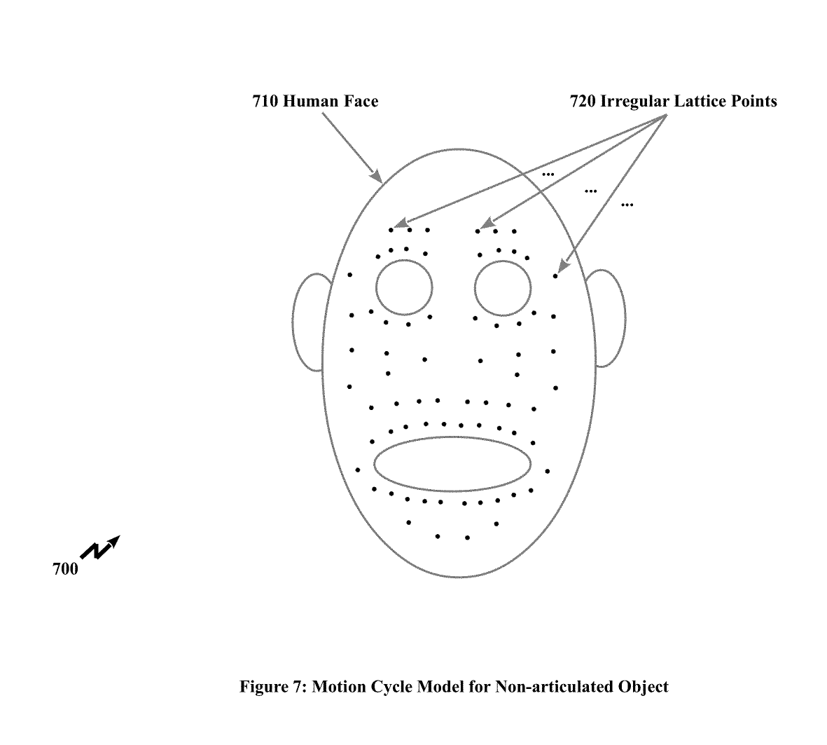

Now referring to FIG. 7 there is depicted an example of a non-articulated structure, in this case a Humanoid Face 710.

The figure also shows Irregular Lattice Points 720 superimposed on the humanoid face. Those points are positioned with respect to the surface of the face using known methods of weighted attachment, and are used to i) gather data values for the motion cycle model when positioned corresponding to shape of the face surface, and ii) drive the shape of the face surface when positioned via state generation using the motion cycle model.

Actuation Cycle

In the case that a sequence of actuation information is available, an actuation cycle model containing that information can be generated similar to the way the motion cycle model is generated from angle and positional information. Such actuation information may be recorded in a sequence in the same form as the positional information in a motion capture sequence. The source of actuation information may be direct, as in the case of an operating robot, or indirect, as in the case of a system containing a particular assembly moving through a particular sequence of positions from which actuation forces and torques can be inferred. The inference of actuation forces and torques can be done using known techniques of inverse kinetics.

In the case of the motion cycle model, parameters associated with a given assembly's motion are identified, values for those parameters are tracked over the course of a cycle of motion, and the curves of those parameter values are analyzed using, for example, a Fourier analysis, to compute the magnitudes and phases of sets of basis functions representating each of the curves.

Embodiments of the current invention would identify parameters associated with the actuation sequence for a given articulated assembly, track those parameter values over the course of a cycle of motion, and analyze the curves of those parameter values to compute the magnitudes and phases of sets of basis functions representating each of the curves. An actuation sequence comprises a set of forces and torques associated with the degrees of freedom of the joints in an articulated assembly. The parameters in an actuation cycle model would correspond to some or all of the elements in the actuation sequence, or aggregate values thereof, where the elements of the actuation sequence correspond to degrees of freedom in the associated assembly.

An embodiment of the current invention may generate an actuation model automatically by creating elements in it corresponding to each degree of freedom for each joint in the associated assembly.

As for embodiments of the current invention for a system containing an assembly and a motion model where additions to, modifications of, or deletions from one of those two can be responded to with corresponding changes in the other, a system containing an assembly, a motion model, and an actuation model would similarly be kept consistent. Additions to, modifications of, or deletions from one of the three components in the system can be responded to with corresponding changes in the other two. For example, if a leg is added to an assembly, a corresponding set of motion property elements can be added to the motion model and a corresponding set of actuation property elements can be added to the actuation model. The new motion property elements would be, for example, position and angle properties of the hip and knee joints and the thigh, shin, and foot segments of the added leg. The new actuation property elements would be, for example, torque information for the three degrees of freedom of the hip ball-and-socket joint, the one degree of freedom of the knee hinge joint, and the three degrees of freedom of the ankle floating joint. And as for the addition of, for example, motion model elements corresponding to the addition of assembly elements, the addition of actuation model elements can be of blank templates or pre-loaded templates from previous or typical cases.

Embodiments of the current invention may include in an actuation model forces and torques related to contacts with external surfaces, for example feet in contact with the ground, where those forces and torques are aligned with motion model elements containing information about the timings and intervals of physical contacts with external surfaces.

Embodiments of the current invention may also treat actuation models similarly to motion models in the other ways that motion models are treated, for examples:
1) an actuation model may be modified by changing the shapes of force or torque curves directly, or by changing magnitude or phase values of the basis functions representing force or torque curves,
2) aggregate properties may be identified in the actuation model, corresponding to aggregate element motions in the motion model. An example is arm swing, whose magnitude may be identified as an aggregate element in a motion model and which may be modified to increase the magnitude of the arm swing motion of the associated assembly. In the actuation model, the vigor of the arm swing, corresponding to the magnitudes of the forces and torques of the joints which move the arms may be identified as an aggregate element.
3) an actuation model can be given a characterization, such as energetic, happy, or angry,
4) an actuation model may represent only part of the actuation of an assembly, for example, arm swing, and
5) the parameters of an actuation model may be viewed as dimensions in a high-dimensional space, allowing for the modification or definition of an actuation model by navigating that space.

In all cases, a consistent set of assembly, motion model, and actuation model represents a system corresponding to a particular desired motion of the assembly.

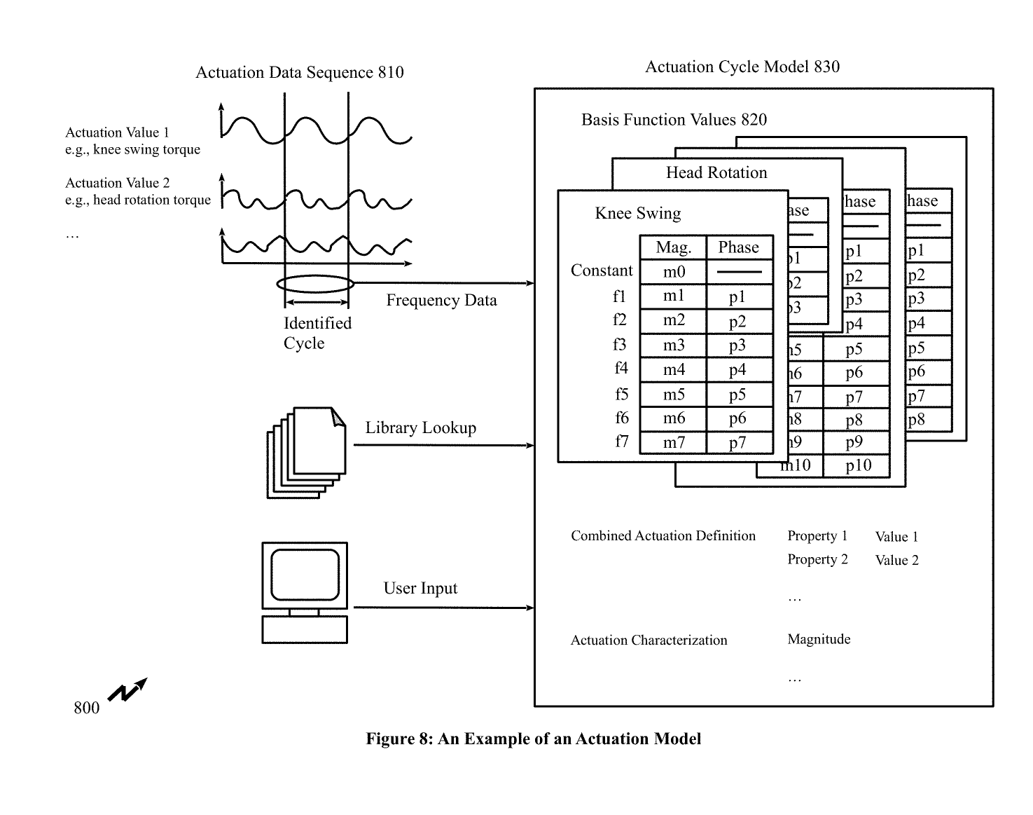

Referring to FIG. 8 there is depicted a block diagram of an actuation cycle model. As for a motion cycle model, there is cyclic data extracted from an Actuation Sequence 810, which for an actuation cycle is the torque and force values for the actuators associated with the degrees of freedom in the joints of an articulated assembly. In one embodiment of the invention the data in the Actuation Sequence is derived using known methods of inverse dynamics from the frame by frame states of an articulated assembly. Also as for a motion cycle model, the actuation cycle is represented as magnitudes and phases for the various values involved, in this case the torques and forces of the joint degree of freedom actuations, as shown by Basis Function Values 820. Embodiments of the invention will pair an actuation cycle model with a motion cycle model since these two models contain parallel information about the motion of an articulated assembly. Thus, an actuation cycle model may also contain i) combined actuation definitions corresponding to combined motion definitions, and ii) actuation cycle characterizations corresponding to motion cycle characterizations. Embodiments of the invention using the same basic representation techniques for the Actuation Cycle Model 830 as for the motion cycle model, can view, analyze, and modify an actuation cycle model in the same ways and using the same tools as for a motion cycle model. Other embodiments of the invention may use different forms to store the actuation information.

The Multimodel

A recorded sequence, such as a motion capture sequence, specifies a particular set of poses for a particular articulated assembly. In the case of a motion capture sequence, a spatial definition of the assembly to which it applies is usually embedded in the same file. For a cyclic motion, a motion model represents the same information as a motion-captured sequence. As discussed above, a motion model may also represent acyclic motion. For producing a motion sequence for, for example, an animated character, a recorded sequence or a motion model are valuable in that i) they are, or can be made to be, consistent with a defined set of physical laws, and ii) its pose states can be retrieved very quickly. Generating the motion sequence manually or via simulation is more expensive and time-consuming.

On the other hand, a recorded sequence or a motion model have the drawback that they cannot be applied to a different articulated assembly, nor can they generate poses representing a different motion. Even a small change to the assembly or to a stored or generated pose can cause significant error in the physical properties of the motion, e.g., the total energy or momentum of the assembly. Such errors, unless very small, will cause visible anomalies in animated characters, and physical failures, e.g., toppling or inelastic deformation, in robots. The only way to ensure that a modified motion is correctly reproduced is to record a modified motion capture sequence or compute a modified motion model. In the case of motion capture, rapid retrieval of a modified model is expensive, if even possible. In the case of a motion model, re-computation with a modification is expensive while pre-computation is less expensive and ensures rapid retrieval.

A multimodel is an aggregation of simpler motion models, each representing a particular, physically correct, motion sequence for a particular articulated assembly. The intention is to span some ranges of properties in order to provide retrieval of poses associated with different values of those properties. A multimodel may also include effects to be applied to poses. As an example, a multimodel which has “gender” as one of its parameters could include hip-sway as an effect to be applied to poses of a walking character, where a generic level of hip-sway is encoded in the other elements of the multimodel. A multimodel also includes a lookup mechanism in the form of, for examples, a table or an algorithmic component. The lookup mechanism may return information in any of the forms contained in the multimodel, that is, it may return complete poses, or a subset of its internal elements allowing for pose construction elsewhere.

For embodiments of the invention which rely on using different motion models to generate a continuous sequence of poses, a particular state for each model is chosen as the starting state, i.e., a phase angle of 0 degrees so that it is possible to generate successive states from different motion models by retrieving them at progressive times or phase angles relative to that marker, as would be done for a single motion model. A more detailed description of this method of the invention is below in Generation of Motion from a Multimodel.

One embodiment of the invention would implement a multimodel as sets of pose sequences. A second embodiment of the invention would implement a multimodel as a set of simpler models. A third embodiment of the invention would implement a multimodel as a set of curves, or more generally a set of n-dimensional manifolds, used to generate specific pose or simpler model parameters. Using smooth curves means that the multimodel can naturally represent all possible parameter value combinations, within defined ranges, rather than interpolating from instances of simpler models. A fourth embodiment of the invention would use a hybrid approach, combining some elements as pose information, some as model information, and some as generative curves.

One embodiment of the invention would represent a multimodel as a set of pose sequences for an articulated assembly, which may be created either by motion capturing each sequence or by generating each sequence from a corresponding motion model.

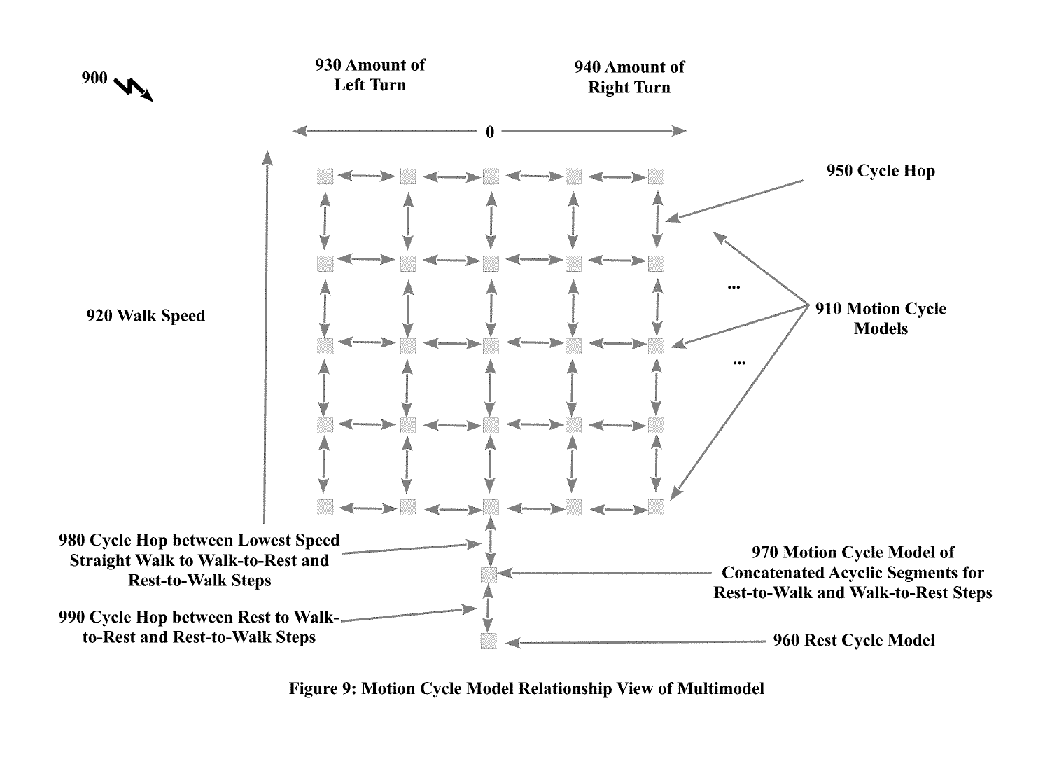

One embodiment of the invention would represent and perform methods on a connected graph of motion cycle models stored in memory, as shown in FIG. 9, where each motion cycle model is used to generate a pose sequence for a particular set of motion cycle parameters. In the example shown in FIG. 9, a two-dimensional lattice of Motion Cycle Models 910 for walk cycles is used to implement the multimodel, where each cycle model specifies the motion for a particular Walk Speed 920 and a particular turning radius, either straight, an Amount of Left Turn 930, or an Amount of Right Turn 940. In addition to the walk cycle models are i) a Motion Cycle Model of Cancatenated Acyclic Segments for Rest-to-Walk and Walk-to-Rest Steps 970, and ii) a Rest Cycle Model 960, which could alternatively be a single rest state.

Still referring to FIG. 9, the lattice points, i.e., motion cycle models, are connected by Cycle Hops 950, 980, and 990. Cycle Hop 950 is an example of a connection between cycle models which spans a range of phases in each cycle model. Recall that generating an articulated assembly state sequence using a motion cycle model refers to generating states using the parameter values computed for phases in the repeating cycle p0, p1, p2, . . . , pN−1, p0, in the range of [0, 2*pi), where p0, p1, p2, etc. correspond to the phases at sequential frame times with respect to the duration of the motion cycle. A cycle hop associated with a range of phases in a pair of cycle models allows switching from one cycle model in the pair to the other for the purposes of generating articulated assembly states at any phase indicated for the one currently being used to generate states. That is, the egress phase from one cycle must be within a defined range, and the ingress phase for the destination cycle is computed to follow the egress phase, taking into account the time passage between state generations. Cycle Hops 980 and 990 are examples of connections between cycle models at specific phases. In order to hop from a walking cycle, to the transition step that a walking assembly would take to enter the rest state, a particular phase in the walk cycle may be chosen as the egress of that cycle to the corresponding ingress phase in the transition cycle model. An embodiment of the invention would use a collection of motion cycle models and cycle hop phase ranges and specific values to form an overall graph representing the repertoire of assembly states to be created for a subject articulated assembly. The path followed through that graph is determined either manually or via an artificial intelligence and corresponds to decisions about the motion directives for the given assembly.

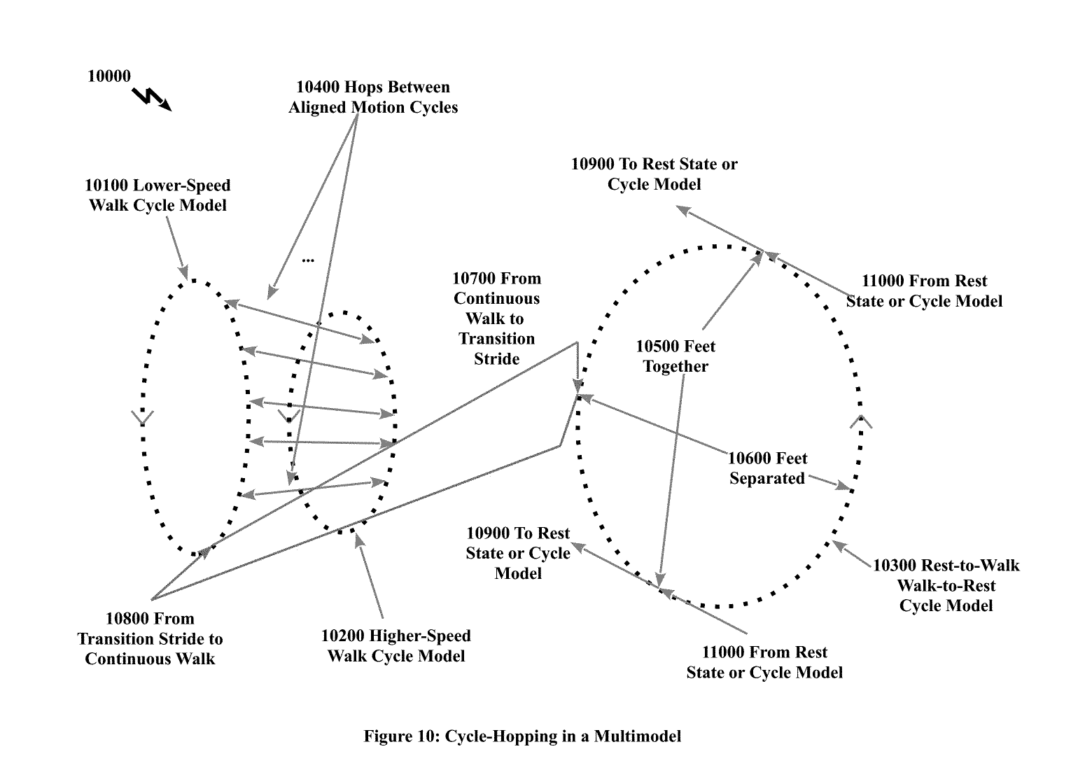

FIG. 10 shows an alternative representation of a portion of a multimodel. In the graph shown, 10000, each motion cycle model is represented as a directed loop, shown in this example with all counter-clockwise progressions, and the hops are represented as arrows between phase locations in the loops. Each cycle model loop, which represents a continuously varying set of parameters for the generation of articulated assembly states, is rendered as a dotted line signifying how specific states would be generated for a fixed frame rate.

In FIG. 10, aligned motion cycles refers to those with ranges of hop phases for moving between them. Examples from a continuous range of hop phases 10400 are shown between a Lower-Speed Walk Cycle Model 10100 and a Higher-Speed Walk Cycle Model 10200. The figure also shows hops 10700 and 10800 at specific egress/ingress phases of the lower speed walk and the Rest-to-Walk Walk-to-Rest Cycle Model 10300.

In all embodiments of the invention, one of the values of the multimodel is to avoid physics computations during character animation or robot motion planning. However, additional modification, and corresponding computation may be done if a parameter of motion not defined for the multimodel is varied. An example is walking on a grade, using a multimodel constructed with only speed and turning radius defined as variable parameters, as shown in the example in FIG. 9. The multimodel may be used to retrieve walking poses as if the character is walking on a level surface, then poses are modified to accommodate the effects of walking on a grade. As examples, depending on the severity and orientation of the grade, the lean of the character may change, the durations of heel and toe contacts may change, and distance of foot contacts from the sagittal plane may change.

Construction of a Multimodel

A multimodel is comprised of a set of elements containing pose information in one of the forms described above, and a lookup mechanism for retrieving that information.

In simplified terms, the information required for the construction of a multimodel is a set of pose sequences which each:
1) represent a motion of given parameter values of an articulated assembly of given parameters, and
2) conform to a given set of physical laws.

A straight-forward source of such a pose sequence is a motion-captured sequence. It is a motion for a particular articulated assembly, a spatial dimensional description of which is often embedded in a motion capture file, performing a defined motion. An example is a walk performed by a particular human being. Generally, the human being is parameterized as the lengths of bones in a connected graph, a skeleton, and the walk is parameterized explicitly as i) of a given character such as casual, energetic, or angry, ii) at a certain speed, iii) on a straight line or on a curve of a given turning radius, and various other ways that one normally describes a human walk, as might be done when giving stage direction to an actor. Significantly, many parameters necessary for a complete physical description and analysis of the motion are omitted from motion capture data. Passive information such as element masses, and surface contact type and timings are generally not included. Active information such as forces and torques exerted by muscles and surface contact are also generally not included.

When using a single unmodified motion capture sequence for the graphical animation of a character, physical analysis can be ignored, provided the character to which the sequence is applied is sufficiently close to the motion capture subject. The motion sequence represents motion associated with a particular set of parameter values. The purpose of the multimodel is to store information about motion over ranges of parameter values. Effectively, it is necessary to generate motion sequences which i) represent motion defined by a given set of parameters, and ii) satisfy the requirement that they conform to a given set of physical laws. The current invention uses a motion model representation defined by a set of parameters. An instance of the motion model has specific values for each of those parameters. A new motion sequence can be generated by i) modifying one or more parameters of the model, and ii) ensuring that the resulting sequence conforms to the given set of physical laws, generally by modifying other model parameters. That modification of other model parameters may be done by a user, or may be done according to preset preferences.

An embodiment of the current invention may contain a method for quantifying the physical correctness of a model, given a specific set of values for its parameters. Such a method calculates a set of measures associated with the motion sequence. The values of those measures might be displayed to a user, possibly alongside desired values and acceptable bounds, or compared automatically against those desired values and acceptable bounds in a process which experiments with modified parameter values to find an acceptable set.

One embodiment of the invention would provide a user interface allowing for the modification of model parameters, and the display the corresponding values of a chosen set of physical measures. In such an embodiment, the user would view the values of the given measures, modify a given parameter as desired, then selectively modify other parameter values as required to bring or keep the given measures at acceptable values.

A second embodiment of the invention would provide a user interface similar to the above but allow the user to specify what parameters may be modified automatically, by what maximum amounts, or in what proportions, in order to keep given measures within acceptable bounds.

As an example, a motion sequence may be measured in the following way:
1) for each instant in time, given a simulation interval or animation frame rate, linear and angular velocities are measured for the entire assembly,
2) the required external force and torque on the assembly since the previous instant in time can be calculated using the current velocities and the ones at the previous time instant,
3) a distribution of forces and torques on external surfaces can be computed using the requirements from ii) and the positions of the external contact points with respect to the center of mass and angular moments of the assembly with respect to those contact points. The distribution of forces and torques may be single values, or related functions. Single values may be the only solution, or may be particular values chosen from the set of possible values using heuristics such as lowest maximum, or lowest total,
4) measures can then be calculated using the solutions or lack of them from iii). If a measure is viewed as a cost function, a computation in iii) that produces no solution is given a very high or infinite cost. A measure may reflect a particular value from the computations done in iii), such as a the force of the left heel on the ground, and be given a cost related to how close it is to a desired value and whether it has exceeded a defined bound. A measure may reflect a derived value from the computations done in iii), such as the magnitude of the knee joint torque, i.e., the corresponding thigh muscle force, and whether it has exceeded a defined bound. A measure may reflect aggregated measures such as the sum of all muscle forces, with a cost that rises sharply as a given muscle approaches or even exceeds it's acceptable limit.

A user presented with the effects of a model parameter modification can experiment with those modifications and produce correct models with modified parameters. Similarly, an automated system that modifies a given parameter, then modifies other parameter values using known methods of gradient search, for example, to ensure correct values for defined measures, can also produce correct models with modified parameters.

As a specific example, if a user has a motion model representing a humanoid biped performing a straight-line walk and would like to create a motion model for a walk at an increased speed. The existing motion model could be used to generate a set of poses for the character moving at a slightly higher speed by setting the position of the character's center of mass (or root element) to a sequence of positions representing a higher speed, then modifying the leg positions for each pose such that surface contact constraints are honored, i.e., so that feet don't slip. Leg positions can be calculated using known methods of inverse kinematics. From the new pose sequence, a motion model can be extracted in the same way that one is extracted from a motion capture sequence, and the sequence of poses can be measured using the four-part procedure described above. For a slightly faster walk, the forces on the feet will change in magnitudes, and the angles of the leg joints will have changed. The user can then modify model parameters to reduce foot forces, for example.

As another specific example, if a user has a motion model representing a humanoid biped performing a straight-line walk and would like to create a motion model for a walk at the same speed but on a 2-meter turning radius. The existing motion model could be used to generate a set of poses for the character following progressively more curved paths by setting the position of the character's center of mass (or root element) to a sequence of positions following the curved path, then modifying the leg positions for each pose such that surface contact constraints are honored, i.e., so that feet don't slip. Leg positions can be calculated using known methods of inverse kinematics. The subsequent sequence of poses can be measured using the four-part procedure described above. For a slightly curved path, the vertical forces on the outside foot will increase to counter centripetal force, and lateral forces on the outside foot will increase as it applies a torque to the assembly to cause it to turn. The user could, for example, then modify the parameter for the angle of the spine to cause the character to lean into its turn. This might be done to change the appearance of the motion when applied to an animated character. Such a change might also be done automatically, with corresponding force and torque changes. It may also be done by either means out of necessity, if the curvature of the path and placement of feet does not allow for a solution without it, i.e., if the assembly would fall over unless it leans.

Generation of Motion from a Multimodel

For motion models representing cyclic motion, such as walking or running, the multimodel can be used to smoothly retrieve assembly state information by moving incrementally through the 360 degrees of a full cycle, while incrementally moving through the parameter space represented in the multimodel. One embodiment of the invention would work as follows:
1) Consider a multimodel representing an assembly walking at a range of speeds and at a range of turning radii.
2) Whichever of the internal formats is used, consider a walk at a fixed speed in a straight line to be one particular motion model in the multimodel. For a given humanoid assembly, the motion through one complete cycle, which would generally be one stride per leg, moves the center of mass of the humanoid a given linear distance. The usual physical equation is true: the distance covered by the cycle of leg motion is equal to the speed times the period, time, of the cycle.
3) Assembly states are usually retrieved at fixed time intervals, e.g., for generating animation frames, by retrieving assembly information at fixed phase intervals through the 360 degrees of a full cycle. As an example, if a given motion cycle represents a walk at 3 meters per second, and the distance covered by the given assembly over one full cycle of walking is 3 meters, the cycle being completed, and begin repeating, in 1 second. For a frame rate of 30 frames per second, 30 frames would be generated for the cycle, at 1/30 second, or 12 degrees increments.
4) When the assembly is required to, for example, increase its speed, assembly states or poses are retrieved from motion models representing walking at progressively higher speeds. Following the example described in 3), if an articulated assembly is to walk at 3 m/s, then accelerate over 1 second to 5 m/s and continue walking at that speed, the method of the invention is as follows:
   1. A series of 30 motion models are created using, or retrieved from, a multimodel representing walks of 3 m/s up to 5 m/s at 1/15 m/s intervals. Models for higher speed walks might have longer strides and have a shorter cycle time, which in combination result in a walking motion at the higher speed. In a given embodiment, the cycles may be aligned such that states for the same phase angles correspond. For example, the cycles may all begin, i.e., at phase 0, with the legs at full extension with the left foot forward and the right foot back. At a phase of 180 degrees, the legs may again be at their full extension but with the right foot forward and the left foot back. As an example, a 5 m/s walk where the distance covered by one cycle of motion has increased to 3.5 m, has a cycle time of 0.7 seconds.
   2. Assembly states are generated at 12 degree intervals from the 3 m/s model until the acceleration is to start.
   3. During the acceleration, one or more assembly state is retrieved from each motion model of progressively higher speed, at progressively later times and phase angles through each cycle. For example, a state is retrieved from the 3 m/s walk cycle model at a phase angle of 0 degrees. In the 3 m/s model, the next state would be generated 12 degrees later in the cycle. In the 3 1/15 m/s model however, the next state would be generated at a phase angle corresponding to the phase progression representing 1/30 seconds. The exact phase angle depends on how much of the increase in speed results from a difference in stride length and how much results from a difference in cycle time. In the case of a normal human walk, a higher speed would result from a longer stride and a shorter cycle time. In that case, the next state would be generated from the 3 1/15 m/s model at 12+ degrees of phase.
   4. After the assembly's speed has reached 5 m/s, that is, after the first state has been retrieved from the 5 m/s model, states continue to be retrieved from the 5 m/s walk cycle model at 1/30 second intervals, that is at phase degree intervals corresponding to a progression through the cycle that, given the distance covered by the motion of the cycle, corresponds to a speed of 5 m/s.
5) The sequence of articulated assembly states retrieved from the multimodel as described in 4) in fact represent snapshots of the assembly at fixed speeds, though a series of progressively faster ones. In some embodiments of the invention that is sufficiently accurate. Where greater physical accuracy is required, an embodiment of the invention may take greater measures such as introducing a leading lean in the pose of the character in order to accommodate a higher backward force on the foot or feet in contact with the ground, which is how the acceleration is produced. The lean and other characteristics may be added after assembly state retrieval from the multimodel, or may be encoded in the information in the multimodel in the same way other parameters are encoded there. Further, an embodiment of the invention may use smooth curves of acceleration such that the modification of the assembly's pose to a forward lean and back is done smoothly.
6) An embodiment of the invention may not explicitly generate the series of motion models describe in 4), but use the multimodel content directly to generate an assembly state for a given set of parameters.
7) The sequence of articulated assembly states may include states generated from motion models for different types of motion, or from different multimodels. For example, an embodiment of the invention may generate states for an assembly in the following order:
   1. states that represent a transition from standing to walking at a low speed, from a motion model or multimodel representing that transition as part of a cycle formed for acyclic motions, as described above,
   2. states that represent the assembly walking at progressively faster, then progressively slower speeds, from a multimodel as described in 4) above,
   3. states that represent a transition from walking to standing, from motion models or a multimodel as described in 1.

Network and Wireless Environments

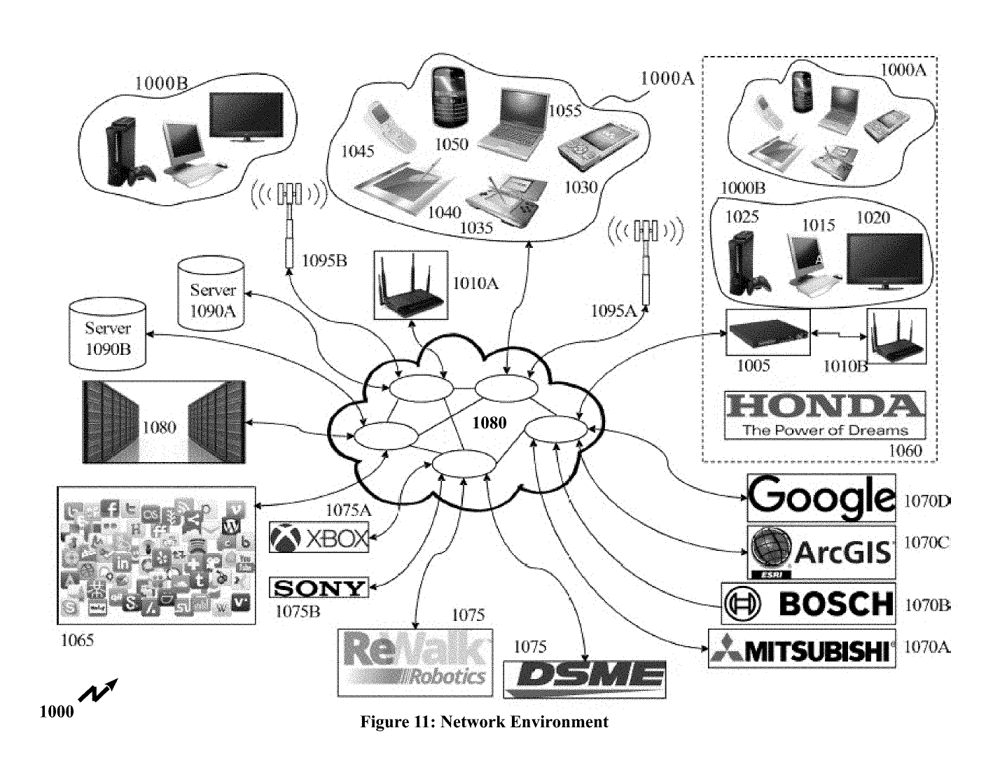

Now referring to FIG. 11 there is depicted a network environment 1000 within which embodiments of the invention may be employed supporting Motion Editor Systems and Motion Editor Applications/Platforms (MES-MEAPs) according to embodiments of the invention. Such MES-MESAPs, for example, supporting multiple communication channels, dynamic filtering, etc. As shown first and second user groups 1000A and 1000B respectively interface to a telecommunications network environment 1000. Within the representative telecommunication architecture, a remote central exchange 1080 communicates with the remainder of a telecommunication service providers network via the network environment 1000 which may include for example long-haul OC-48/OC-192 backbone elements, an OC-48 wide area network (WAN), a Passive Optical Network, and a Wireless Link. The central exchange 1080 is connected via the network environment 1000 to local, regional, and international exchanges (not shown for clarity) and therein through network environment 1000 to first and second cellular APs 1095A and 1095B respectively which provide Wi-Fi cells for first and second user groups 1000A and 1000B respectively. Also connected to the network environment 1000 are first and second Wi-Fi nodes 1010A and 1010B, the latter of which being coupled to network environment 1000 via router 1005.

Second Wi-Fi node 1010B is associated with commercial service provider 1060, e.g. Honda™, comprising other first and second user groups 1000A and 1000B. Second user group 1000B may also be connected to the network environment 1000 via wired interfaces including, but not limited to, DSL, Dial-Up, DOCSIS, Ethernet, G.hn, ISDN, MoCA, PON, and Power line communication (PLC) which may or may not be routed through a router such as router 1005.

Within the cell associated with first AP 1010A the first group of users 1000A may employ a variety of PEDs including for example, laptop computer 1055, portable gaming console 1035, tablet computer 1040, smartphone 1050, cellular telephone 1045 as well as portable multimedia player 1030. Within the cell associated with second AP 1010B are the second group of users 1000B which may employ a variety of FEDs including for example gaming console 1025, personal computer 1015 and wireless/Internet enabled television 1020 as well as cable modem 1005. First and second cellular APs 1095A and 1095B respectively provide, for example, cellular GSM (Global System for Mobile Communications) telephony services as well as 3G and 4G evolved services with enhanced data transport support. Second cellular AP 1095B provides coverage in the exemplary embodiment to first and second user groups 1000A and 1000B. Alternatively the first and second user groups 1000A and 1000B may be geographically disparate and access the network environment 1000 through multiple APs, not shown for clarity, distributed geographically by the network operator or operators. First cellular AP 1095A as show provides coverage to first user group 1000A and environment 1070, which comprises second user group 1000B as well as first user group 1000A. Accordingly, the first and second user groups 1000A and 1000B may according to their particular communications interfaces communicate to the network environment 1000 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 1000A may form associations either through standards such as IEEE 802.15 and Bluetooth as well in an ad-hoc manner.

Also connected to the network environment 1000 are Social Networks (SOCNETS) 1065, first and second original equipment manufacturers (OEMs) 1070A and 1070B respectively, e.g. Mitsubishi™ and Bosch™, first and second third party service providers 1070C and 1070D respectively, e.g. ArcGIS™ and Google™. Also connected to the network environment 1000 are first and second entertainment system providers 1075A and 1075B respectively, e.g. Microsoft Xbox™ and Sony™ together with first and second robotic exoskeleton manufacturers, e.g. ReWalk Robotics™ and DSME™ (division of Daewoo), together with others, not shown for clarity. Accordingly, a user such as commercial service provider 1060 engages with multiple users, e.g. other commercial and/or individuals to provide dynamic motion systems to them. Accordingly, these devices, systems, etc. exploiting MES-MESAPs may access resources including those within their own organization, e.g. commercial service provider 1060 (Honda™), together with first and second OEMs 1070A and 1070B respectively, e.g. Mitsubishi™ and Bosch™, or other service providers such as first and second service providers 1070C and 1070D respectively, ArcGIS™ and Google™. For example, first and second entertainment system providers 1075A and 1075B respectively, e.g. Microsoft Xbox™ and Sony™, may exploit MES-MESAPs either to generate motion of characters, equipment, robotic systems etc. within the gaming environment or control/manage/design a device/system associated with a gaming environment for example. Alternatively, first and second robotic exoskeleton manufacturers, e.g. ReWalk Robotics™ and DSME™, may exploit MES-MESAPs according to embodiments of the invention to design/manage/control exoskeleton systems.

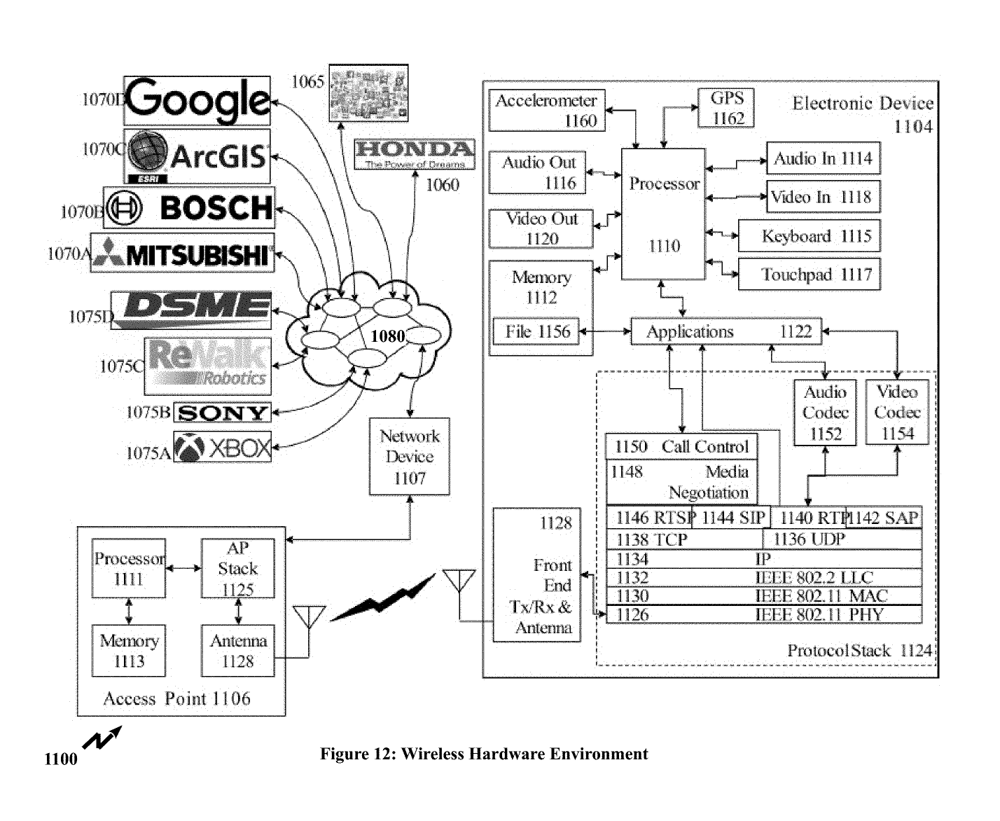

For example, a user with a robotic exoskeleton hip replacement may have the hip replacement exploiting MES-MESAP features according to embodiments of the invention. Referring to FIG. 12, Electronic device 1104 may, for example, be a PED and/or FED and may include additional elements above and beyond those described and depicted. Also depicted within the electronic device 1104 is the protocol architecture as part of a simplified functional diagram of a system 1100 that includes an electronic device 1104, such as a smartphone 1055, an access point (AP) 1106, such as first AP 1010, and one or more network devices 1107, such as communication servers, streaming media servers, and routers for example such as first and second servers 1090A and 1090B respectively. Network devices 1107 may be coupled to AP 1106 via any combination of networks, wired, wireless and/or optical communication links such as discussed above in respect of FIG. 12 as well as directly as indicated. Network devices 1107 are coupled to network environment 1000 and therein Social Networks (SOCNETS) 1065, first and second original equipment manufacturers (OEMs) 1070A and 1070B respectively, e.g. Mitsubishi™ and Bosch™, first and second third party service providers 1070C and 1070D respectively, e.g. ArcGIS™ and Google™. Also connected to the network environment 1000 are first and second entertainment system providers 1075A and 1075B respectively, e.g. Microsoft Xbox™ and Sony™ together with first and second robotic exoskeleton manufacturers, e.g. ReWalk Robotics™ and DSME™ (division of Daewoo), together with others, not shown for clarity.

The electronic device 1104 includes one or more processors 1110 and a memory 1112 coupled to processor(s) 1110. AP 1106 also includes one or more processors 1111 and a memory 1113 coupled to processor(s) 1110. A non-exhaustive list of examples for any of processors 1110 and 1111 includes a central processing unit (CPU), a digital signal processor (DSP), a reduced instruction set computer (RISC), a complex instruction set computer (CISC) and the like. Furthermore, any of processors 1110 and 1111 may be part of application specific integrated circuits (ASICs) or may be a part of application specific standard products (ASSPs). A non-exhaustive list of examples for memories 1112 and 1113 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 1104 may include an audio input element 1114, for example a microphone, and an audio output element 1116, for example, a speaker, coupled to any of processors 1110. Electronic device 1104 may include a video input element 1118, for example, a video camera or camera, and a video output element 1120, for example an LCD display, coupled to any of processors 1110. Electronic device 1104 also includes a keyboard 1115 and touchpad 1117 which may for example be a physical keyboard and touchpad allowing the user to enter content or select functions within one of more applications 1122. Alternatively, the keyboard 1115 and touchpad 1117 may be predetermined regions of a touch sensitive element forming part of the display within the electronic device 1104. The one or more applications 1122 that are typically stored in memory 1112 and are executable by any combination of processors 1110. Electronic device 1104 also includes accelerometer 1160 providing three-dimensional motion input to the process 1110 and GPS 1162 which provides geographical location information to processor 1110.

Electronic device 1104 includes a protocol stack 1124 and AP 1106 includes a communication stack 1125. Within system 1100 protocol stack 1124 is shown as IEEE 802.11 protocol stack but alternatively may exploit other protocol stacks such as an Internet Engineering Task Force (IETF) multimedia protocol stack for example. Likewise, AP stack 1125 exploits a protocol stack but is not expanded for clarity. Elements of protocol stack 1124 and AP stack 1125 may be implemented in any combination of software, firmware and/or hardware. Protocol stack 1124 includes an IEEE 802.11-compatible PHY module 1126 that is coupled to one or more Front-End Tx/Rx & Antenna 1128, an IEEE 802.11-compatible MAC module 1130 coupled to an IEEE 802.2-compatible LLC module 1132. Protocol stack 1124 includes a network layer IP module 1134, a transport layer User Datagram Protocol (UDP) module 1136 and a transport layer Transmission Control Protocol (TCP) module 1138.

Protocol stack 1124 also includes a session layer Real Time Transport Protocol (RTP) module 1140, a Session Announcement Protocol (SAP) module 1142, a Session Initiation Protocol (SIP) module 1144 and a Real Time Streaming Protocol (RTSP) module 1146. Protocol stack 1124 includes a presentation layer media negotiation module 1148, a call control module 1150, one or more audio codecs 1152 and one or more video codecs 1154. Applications 1122 may be able to create maintain and/or terminate communication sessions with any of devices 1107 by way of AP 1106. Typically, applications 1122 may activate any of the SAP, SIP, RTSP, media negotiation and call control modules for that purpose. Typically, information may propagate from the SAP, SIP, RTSP, media negotiation and call control modules to PHY module 1126 through TCP module 1138, IP module 1134, LLC module 1132 and MAC module 1130.

It would be apparent to one skilled in the art that elements of the electronic device 1104 may also be implemented within the AP 1106 including but not limited to one or more elements of the protocol stack 1124, including for example an IEEE 802.11-compatible PHY module, an IEEE 802.11-compatible MAC module, and an IEEE 802.2-compatible LLC module 1132. The AP 1106 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 1104 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 12 depicts an Electronic Device 1104, e.g. a PED, wherein one or more parties including, but not limited to, a user, users, an enterprise, enterprises, third party provider(s), wares provider(s), service provider(s), original equipment manufacturer, designer, design studio, component supplier, etc. may engage in one or more activities with a MES-MESAP according to embodiments of the invention.

For example, a user's prosthesis, such as a leg for example, may be designed and specified using a MES-MESAP according to an embodiment of the invention. Such a prosthesis would be typically powered, what the inventor refers to as an active exoskeleton, rather than an unpowered (passive exoskeleton) prosthesis such as a hip replacement. Accordingly, the prosthesis rather than operating in fixed predetermined modes such as within the prior art, e.g. walk, climb stairs, may operate in an adaptive mode wherein the current context/environment of the user and the desired result for the user are inputs to the Motion Editor/MES-MESAP according to an embodiment of the invention and accordingly the active exoskeleton responds to the context/environment/desired result in real time. In this manner the Motion Editor/MES-MESAP may establish a terrain specification of the solution property space based upon the user's current location and a mode specification of the solution property space based upon either the user's current mode, e.g. walk, or a selection made by the user, e.g. step up or walk and step-up.

Additionally, the MES-MESAP may monitor sensors associated with the modeled and implemented system so that the MES-MESAP obtains feedback directly or this may also be fed back to remote databases for assessment versus the desired (target) motion in order to identify common restrictions/limitations that the dynamic motion system presents to users. Accordingly, remote servers may identify limitations, unforeseen circumstances, segment/joint aging characteristics etc. Such factors may be introduced into lifetime assessments of dynamic motion systems whether exoskeletons, androids, remote devices, etc. as well as providing unique characteristics to simulated environments such that the behavior of an “old” android may be different from a “new” android of the same design.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Embodiments of the invention may distribute components between the clients and servers in a client-server or peer-to-peer environment in order to allow those components to interact.

What is claimed is:

1. A method comprising:
1. establishing within a memory of a computer system a set of cyclic motion curves representing an articulated motion specification for an articulated assembly; wherein each curve comprises a set of basis functions defined by a plurality of magnitudes and a plurality of phases each associated with a predetermined magnitude of the plurality of magnitudes; wherein
2. such motion curves are individually or in groups added to or removed from the set in memory corresponding to the addition or removal of structural elements to or from the articulated assembly; and
3. executing with the computer system a motion simulator to generate simulated motion of the articulated assembly; wherein the simulated motion is established in dependence upon at least the set of motion curves representing the articulated motion specification for the articulated assembly.

2. The method according to claim 1, wherein the cyclic motion curves are derived from a cyclic series of poses for an articulated assembly, wherein the cyclic series of poses is constructed as the concatenation of a plurality of acyclic series of poses, related to each other via mirroring or time-reversal, such that the constructed series of poses represents a continuous motion that begins and ends in the same state.

3. The method according to claim 1, wherein the cyclic motion curves are augmented with corresponding information established within a memory of a computer system about cyclic contacts of articulated assembly elements with a support surface, wherein the contact information includes
1. the type of contact pattern, and
2. the timings of contact initiations and terminations relative to each other and to the overall phase of the cyclic motion curves.

4. The method according to claim 1, wherein the cyclic motion curves are augmented with information established within a memory of a computer about the motion symmetries to be enforced on the motion curves when they are modified.

5. The method of claim 1, wherein the subject of the motion cycle is a non-articulated structure, wherein
1. the non-articulated structure is defined as a continuous mass with a defined surface; and
2. the motion data used to generate motion cycle curves relates to the positions, orientations, and other properties of chosen points on the surface and within the mass of the non-articulated structure.

6. A method comprising:
1. establishing within a memory of a computer system a set of cyclic actuation curves representing an actuation specification for an articulated assembly; wherein each curve comprises a set of basis functions defined by a plurality of magnitudes and a plurality of phases each associated with a predetermined magnitude of the plurality of magnitudes; wherein
2. such actuation curves are individually or in groups added to or removed from the set in memory corresponding to the addition or removal of structural elements to or from the articulated assembly; and
3. executing with the computer system a motion simulator to generate simulated motion of the articulated assembly; wherein the simulated motion is established in dependence upon at least the set of the assembly's response to the actuation curves representing the actuation specification for the articulated assembly.

7. A method comprising:
1. establishing within a memory of a computer system a set of motion cycle models and relationships between them; wherein
1. each motion cycle model represents an articulated motion specification for an articulated assembly; and
2. a relationship between a pair of motion cycle models is a single point value or a range of egress phases and corresponding ingress phases for transitioning the articulated assembly state generation from one motion cycle model to the other such that the sequence of states generated represents visually and physically smooth motion, within defined tolerances; and
2. executing with the computer system a motion simulator to generate simulated motion of the articulated assembly; wherein the simulated motion is established in dependence upon at least the set of motion curves representing the articulated motion specification for the articulated assembly by one of the motion cycle models.
